(19) United States
(12) Patent Application Publication
(10) Pub. No.: US 2024/0284351 A1
(43) Pub. Date: Aug. 22, 2024

(54) SYSTEM AND METHOD FOR OPTIMIZING TRANSMISSION POWER OF ANTENNA ARRAY BY USING FEEDBACK SIGNAL

(71) Applicant: Telefonaktiebolaget LM Ericsson (publ), Stockholm (SE)

(72) Inventors: Magnus NILSSON, Lund (SE); Leonard REXBERG, Hässelby (SE)

(21) Appl. No.: 18/693,364

(22) PCT Filed: Sep. 21, 2021
(86) PCT No.: PCT/EP2021/075904

§ 371 Date: Mar. 19, 2024

(51) Int. Cl. H04W 52/42; H04W 52/24

(52) U.S. Cl. CPC H04W 52/42; H04W 52/241

(57) ABSTRACT

Optimizing transmission powers of antenna arrays in base stations by using feedback signals from multiple wireless communication devices. A method performed by the base stations includes identifying a first served wireless communication device and a second served wireless communication device; transmitting a first signal to the first served wireless communication device via the antenna array with a first initial set of phase values and a second signal to the second served wireless communication device via the antenna array with a second initial set of phase values; receiving a first measurement of the first signal from the first served wireless communication device and a second measurement of the second signal from the second served wireless communication device; and performing a calibration procedure based on the first measurement to provide a first calibrated set of phase values and the second measurement to provide a second calibrated set of phase values.

### TECHNICAL FIELD

The present disclosure relates to systems and methods for optimizing or maximizing transmission power of antenna elements in an antenna array by using a feedback signal representing, e.g., a measurement of Signal to Interference-plus-Noise Ratio (SINR) (such as Channel Quality Indicator (CQI)) received from multiple wireless communication devices.

### BACKGROUND

Demands for high bitrates in wireless communication systems continue to increase. Low frequency spectrum has been filled up, and thus, a higher frequency spectrum has been taken into use. In Fifth Generation (5G) System (5GS), a new higher frequency range, FR2 (24250 MHz-52600 MHz), was introduced. At these high frequencies, as path loss increases, cell sizes and cell capacities are degraded. Thus, in 5G, a technology called “beamforming” was introduced to increase both the cell capacities and cell coverages. In Sixth Generation (6G), even higher frequencies will be used to overcome the increased path loss.

Beamforming and beam steering are made from coherently combining Radio Frequency (RF) signals from smaller antenna branches. By phase shifting or amplifying the signal into the antenna branches, a desired beam is formed. This technology of beamforming contributes to a mitigation of the above-listed problems (increased path loss, degraded cell sizes and cell capacities) by means of radically increasing a beam gain and restoring the rated Equivalent Isotropic Radiated Power (EIRP) rating of Millimeter-Wave (mmW) base stations to usable levels.

A popular, low complexity way of doing beamforming is analog beamforming. Here, the signals to or from the antennas are beamformed in the RF domain. The rest of the signal chain is common to all or a portion of the antenna branches. Then, all the data are converted into a time-domain stream early, before being sent to the radio Application-Specific Integrated Circuits (ASICs) and antennas. Since one set of beam weights is applied in the duration of one Orthogonal Frequency Division Multiplexing (OFDM) symbol, the beam is, therefore, spatially fixed for all data. Although the beam may have peaks in multiple directions, the data stream will be transmitted through one beam pattern, which limits the possibility to simultaneously transmit data to multiple users. In other words, the transmission of the data stream through one beam pattern is not desirable because it would be advantageous to direct different data streams in different directions by frequency selective scheduling. When using the analog beamforming, normally, only one spatial direction is used at a time to improve coverage. If the capacity is intended to be improved by exploiting spatial diversity, the panel may be split into multiple subpanels.

In a high path loss case, all the antenna branches in the antenna array is used to maximize EIRP and the sensitivity of the antenna array. For example, when wireless communication devices (e.g., User Equipment) are in good coverage conditions, the panels of the antenna array may be split into, for example, 4 sub-panels and then the overall capacity may be fourfold. In this case, the 4 sub-panels use the same frequency range and the spatial isolation of the 4 sub-panels is used to allow simultaneous transmissions or receptions. This imposes stringent requirements on the spatial beam quality of the antenna array. In the downlink, one beam arriving at each wireless communication device will be impacted by interferences from three other beams. In the uplink, we may have access to all wireless communication device data streams and may perform more complex receiver algorithms, for example, using successive cancellation. The complex receiver algorithms for the uplink are normally not applicable in the downlink due to limited processing power in the wireless communication device and interferences.

For example, 64 Quadrature Amplitude Modulation (QAM) running at high code rate requires ˜20 dB Signal to Interference-plus-Noise Ratio (SINR) in each receiver of the wireless communication devices. This is due to limited beam isolations, for example, which are caused by the existence of the other three interferers. For example, each beam needs to have sidelobe levels lower than 24.8 dB (20+10*log₁₀(3)). The array size and the type of tapering will affect the sidelobe levels. For example, an 8 by 16 array with tapering down to 25 dB sidelobe level will get 2.8 dB loss in EIRP. In this foregoing analysis, the tapered beam pattern does not have impairments, such as limited resolution, antenna calibration, and temperature variations, etc.

The accuracy requirements of beamforming per each element are very different if comparing (a) only generating an accurate beam direction with high EIRP and (b) generating a tapered beam with very low sidelobe levels. In the case of (a), if we only want to have sufficient EIRP, a 20° Root-Mean-Square (RMS) phase error over an 8 by 16 element array will only give as little as 0.02 dB RMS error to the main beam. In addition, no amplitude part is required in the beamforming. On the other hand, in the case of (b), if using the tapering, phase and amplitude errors will impose varying level of sidelobes. FIG. 2 illustrates the impact of limited phase resolution. The upper graph of FIG. 2 shows the beampattern without impairments and the lower graph of FIG. 2 shows an impact of adding 5-bit phase quantization=>11.25 degree step size corresponding to 5.6° RMS phase error.

### SUMMARY

Embodiments for optimizing or maximizing transmission powers of antenna branches of an antenna array in a base station by using a feedback signal representing, e.g., a measurement of Signal to Interference-plus-Noise Ratio (SINR) (such as Channel Quality Indicator (CQI)) received from multiple wireless communication devices are disclosed herein. Embodiments of a method performed by a base station are disclosed. In one embodiment the method performed by the base station comprises identifying a first served wireless communication device and a second served wireless communication device, transmitting a first signal to the first served wireless communication device via the antenna array with a first initial set of phase values applied to the antenna branches in the antenna array, and transmitting a second signal to the second served wireless communication device via the antenna array with a second initial set of phase values applied to the antenna branches in the antenna array. The method further comprises receiving a first measurement of the first signal, e.g., a measurement of SINR of the first signal (such as a CQI), from the first served wireless communication device, and receiving a second measurement of the second signal, e.g., a measurement of SINR of the second signal (such as a CQI), from the second served wireless communication device. The method further comprises performing at least one calibration procedure based on the first measurement and the second measurement to provide a first calibrated set of phase values for transmission to the first served wireless communication device and a second calibrated set of phase values for transmission to the second wireless communication device. In this manner, the accuracy requirements of beamforming by the base station may be relaxed. Also, without adopting any new feedback signals in the communication system, already-used feedback signals, e.g. CQIs, may be used to optimize or maximize transmission powers of the antenna branches of the antenna array in the base station.

In one embodiment, the method further comprises transmitting a third signal to the first served wireless communication device via the antenna array with the first calibrated set of phase values for the antenna branches in the antenna array; and transmitting a fourth signal to the second served wireless communication device via the antenna array with the second calibrated set of phase values for the antenna branches in the antenna array.

In one embodiment, the first measurement is comprised in a CQI received from the first served wireless communication device.

In one embodiment, any of the first measurement and the second measurement comprises SINR.

In one embodiment, each of the first initial set of phase values or the second initial set of phase values is applied to a respective set of one or more antenna branches.

In one embodiment, each respective set of one or more antenna branches is a single antenna branch.

In one embodiment, each respective set of one or more antenna branches comprises two or more antenna branches.

In one embodiment, performing the at least one calibration procedure comprises a K-number of iterations. For each iteration k of the K-number of iterations where k=0, 1, . . . , K, performing the at least one calibration procedure comprises transmitting a k-th signal to the first served wireless communication device or to the second served wireless communication device via the antenna array with a k-th set of phase values (αₖ) applied to the antenna branches in the antenna array; receiving a k-th measurement for the k-th signal from the first served wireless communication device or from the second served wireless communication device; calculating a k-th set of phase difference values (Δαₖ) based on the k-th measurement and the k-th set of phase values (αₖ); and calculating a (k+1)-th set of phase values (αₖ₊₁) based on the k-th set of phase values (αₖ) and the k-th set of phase difference values (Δαₖ).

In one embodiment, calculating a k-th set of phase difference values (Δαₖ) based on the k-th measurement and the k-th set of phase values (αₖ) comprises calculating the k-th set of phase difference values (Δαₖ) based on a first predefined function, which comprises an inverse Hessian matrix having diagonal elements configured to maximize signal transmission power and a Gradient vector that receives the k-th measurement as an input variable.

In one embodiment, the K-number of iterations are divided and assigned to the first served wireless communication device and the second served wireless communication device in an interleaved manner.

In one embodiment, the interleaved manner is determined by a modulo function.

In one embodiment, the method further comprises identifying a first victim wireless communication device among the plurality of wireless communication devices and transmitting a third signal to the first victim wireless communication device via the antenna array with a third initial set of phase values applied to the antenna branches in the antenna array. The method further comprises receiving a third measurement of the third signal from the first victim wireless communication device and performing at least one beam isolation procedure (i) based on the first measurement to provide the first calibrated set of phase values for the antenna branches in the antenna array and (ii) based on the third measurement to provide a third calibrated set of phase values for the antenna branches in the antenna array.

In one embodiment, the method further comprises transmitting a fourth signal to the first served wireless communication device via the antenna array with the first calibrated set of phase values and the third calibrated set of phase values for the antenna branches in the antenna array.

In one embodiment, performing the at least one beam isolation procedure comprises a K-number of iterations. For each iteration k of the K-number of iterations where k=0, 1, . . . , K, performing the at least one beam isolation procedure comprises transmitting a k-th signal to the first served wireless communication device or to the first victim wireless communication device via the antenna array with a k-th set of phase values (αₖ) applied to the antenna branches in the antenna array; receiving a k-th measurement for the k-th signal from the first served wireless communication device or from the first victim wireless communication device; calculating a k-th set of phase difference values (αₖ) based on the k-th measurement and the k-th set of phase values (αₖ); and calculating a (k+1)-th set of phase values (αₖ₊₁) based on the k-th set of phase values (αₖ) and the k-th set of phase difference values (Δαₖ).

In one embodiment, calculating a k-th set of phase difference values (Δαₖ) based on the k-th measurement and the k-th set of phase values (αₖ) comprises calculating the k-th set of phase difference values (Δαₖ) based on: (i) a first predefined function comprising a first inverse Hessian matrix having first diagonal elements configured to maximize signal transmission power and a first Gradient vector that receives the k-th measurement as an input variable; or a second predefined function comprising a second inverse Hessian matrix having second diagonal elements configured to minimize signal transmission power and a second Gradient vector that receives the k-th measurement as an input variable.

In one embodiment, the first diagonal elements of the first inverse Hessian matrix and the second diagonal elements of the second inverse Hessian matrix have the opposite signs.

In one embodiment, the K-number of iterations are divided and assigned to the first served wireless communication device and the first victim wireless communication device in an interleaved manner.

In one embodiment, the interleaved manner is determined by a modulo function.

Corresponding embodiment of a base station are also disclosed. In one embodiment, a base station is adapted to identify a first served wireless communication device and a second served wireless communication device; transmit a first signal to the first served wireless communication device via the antenna array with a first initial set of phase values applied to the antenna branches in the antenna array and a second signal to the second served wireless communication device via the antenna array with a second initial set of phase values applied to the antenna branches in the antenna array and to receive a first measurement of the first signal, e.g. a measurement of SINR of the first signal (such as a CQI), from the first served wireless communication device, and a second measurement of the second signal, e.g. a measurement of SINR of the second signal (such as a CQI), from the second served wireless communication device. The base station further performs at least one calibration procedure based on the first measurement to provide a first calibrated set of phase values and the second measurement to provide a second calibrated set of phase values.

In one embodiment, a base station comprises processing circuitry configured to cause the base station to identify a first served wireless communication device and a second served wireless communication device and to transmit a first signal to the first served wireless communication device via the antenna array with a first initial set of phase values applied to the antenna branches in the antenna array and a second signal to the second served wireless communication device via the antenna array with a second initial set of phase values applied to the antenna branches in the antenna array. The processing circuitry is further configured to cause the base station to receive a first measurement of the first signal, e.g. a measurement of SINR of the first signal (such as a CQI), from the first served wireless communication device, and a second measurement of the second signal, e.g. a measurement of SINR of the second signal (such as a CQI), from the second served wireless communication device and to perform at least one calibration procedure based on the first measurement to provide a first calibrated set of phase values and the second measurement to provide a second calibrated set of phase values.

### BRIEF DESCRIPTION OF THE DRAWINGS

The accompanying drawing figures incorporated in and forming a part of this specification illustrate several aspects of the disclosure, and together with the description serve to explain the principles of the disclosure. Optional features are represented by dashed boxes.

FIG. 1 illustrates one example of a cellular communications system;

FIG. 2 illustrates impacts of limited phase resolution;

FIG. 3 illustrates an example of an antenna array comprising multiple antenna branches;

FIG. 4 illustrates an example of a one-dimensional (1D) antennary array comprising multiple antenna branches according to some embodiments of the present disclosure;

FIG. 5 illustrates an example of an antenna array comprising multiple sub-panels according to some embodiments of the present disclosure;

FIG. 6 illustrates an example of intra-panel antenna branch calibration toward a served wireless communication device according to some embodiments of the present disclosure;

FIG. 7 illustrates programmatic flow charts for the embodiment of calibrating intra-panel antenna branches toward one served wireless communication device;

FIG. 8 illustrates an example of uncalibrated radiation pattern (left) of 8 elements of the 1D antenna array and an example of calibrated radiation pattern (right) of the 8 elements of the 1D antenna array according to some embodiments of the present disclosure;

FIG. 9 illustrates an example of uncalibrated radiation pattern (left) of 16 elements of the 1D antenna array and an example of calibrated radiation pattern (right) of the 16 elements of the 1D antenna array according to some embodiments of the present disclosure;

FIG. 10 illustrates an example of uncalibrated radiation pattern (left) of 32 elements of the 1D antenna array and an example of calibrated radiation pattern (right) of the 32 elements 1D antenna array according to some embodiments of the present disclosure;

FIG. 11 illustrates an example of uncalibrated radiation pattern (left) of 64 elements of the 1D antenna array and an example of calibrated radiation pattern (right) of the 64 elements of the 1D antenna array according to some embodiments of the present disclosure;

FIG. 12 illustrates an example of uncalibrated radiation pattern (left) of 8 elements of the 1D antenna array with 4 sub-panels and an example of calibrated radiation pattern (right) of the 8 elements 1D antenna array with 4 sub-panels according to some embodiments of the present disclosure;

FIG. 13 illustrates an example of a calibrating procedure for at least two served wireless communication devices according to some embodiments of the present disclosure;

FIG. 14A illustrates a flow chart of the calibration procedure for the at least two wireless communication devices according to some embodiments of the present disclosure;

FIG. 14B illustrates sub-steps of the calibration procedure illustrated in FIG. 14A;

FIG. 15 illustrates a programmatic flow chart for the embodiment of the calibration procedure for the at least two wireless communication devices;

FIG. 16 illustrates an example of performing a beam isolation procedure regarding an antenna beam toward a first victim wireless communication device according to some embodiments of the present disclosure;

FIG. 17A illustrates a flow chart of the beam isolation procedure regarding the first served wireless communication device and the first victim wireless communication device according to some embodiments of the present disclosure;

FIG. 17B illustrates sub-steps of the beam isolation procedure illustrated in FIG. 17A;

FIG. 18 illustrates programmatic flow charts for the embodiment of the beam isolation procedure regarding the first served wireless communication device and the first victim wireless communication device;

FIG. 19 illustrates an example of uncalibrated radiation pattern (left) of the antenna array and an example of uncalibrated radiation pattern (right) with a nulling of the antenna array according to some embodiments of the present disclosure;

FIG. 20 illustrates an example of uncalibrated radiation pattern (left) of the antenna array and an example of uncalibrated radiation pattern (right) with two nullings of the antenna array according to some embodiments of the present disclosure;

FIG. 21 illustrates an example of uncalibrated radiation pattern (left) of the antenna array and an example of calibrated radiation pattern (right) with a nulling of the antenna array according to some embodiments of the present disclosure;

FIG. 22 illustrates an example of calibrated radiation pattern (left) of an antenna array and an example of calibrated radiation pattern (right) with two nullings of the antenna array according to some embodiments of the present disclosure;

FIG. 23 illustrates an example of uncalibrated radiation beam pattern (left) of an antenna array and calibrated radiation beam pattern (right) with two nullings of the antenna array according to some embodiments of the present disclosure;

FIG. 24 illustrates an example of nulling two antenna beams toward two victim wireless communication devices according to some embodiments of the present disclosure;

FIG. 25 illustrates a programmatic flow chart for the embodiment of nulling two antenna beams toward two victim wireless communication devices;

FIG. 26 illustrates an example of dividing a service area to multiple sub-panels according to some embodiments of the present disclosure;

FIG. 27 is a schematic block diagram of a radio access node according to some embodiments of the present disclosure;

FIG. 28 is a schematic block diagram that illustrates a virtualized embodiment of the radio access node of FIG. 27 according to some embodiments of the present disclosure;

FIG. 29 is a schematic block diagram of the radio access node of FIG. 27 according to some other embodiments of the present disclosure;

FIG. 30 is a schematic block diagram of the wireless communication device according to some embodiments of the present disclosure; and

FIG. 31 is a schematic block diagram of the wireless communication device of FIG. 30 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

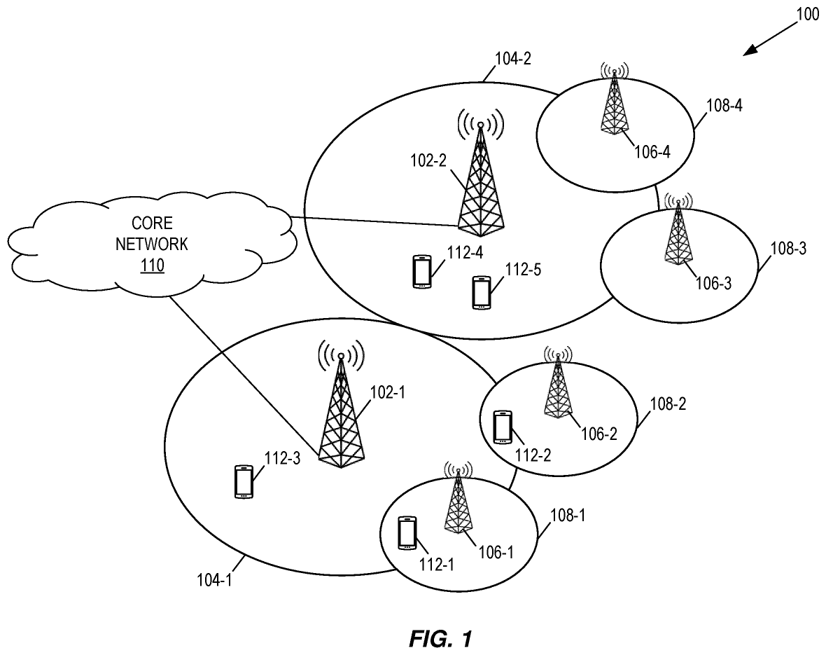

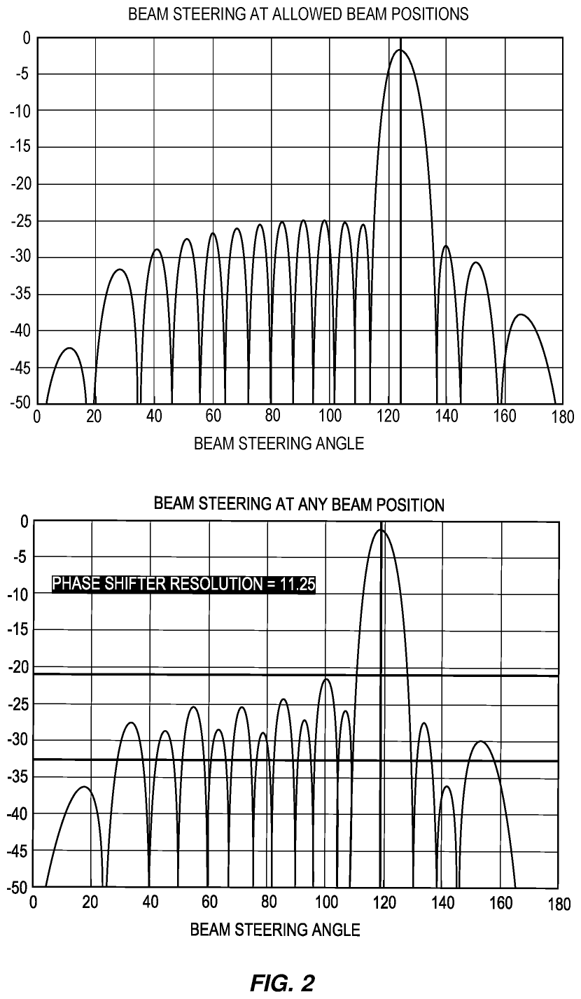

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 102-1 and 102-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108.

The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto. The base stations 102 may include one or more antenna arrays each including multiple antenna branches, as will be appreciated by those of ordinary skill in the art.

Before describing further details of embodiments of the present disclosure, a discussion of problems with existing solutions is beneficial. When using analog beamforming combined with multiple antenna arrays (also referred to herein as “panels”) to improve cell capacity, isolation of antenna beams becomes an issue. Only spatial isolation of the antenna beams is used to separate multiple users and bad beam qualities will degrade Signal to Interference-plus-Noise Ratio (SINR) on each of the received signals. If a uniformly distributed antenna array is used with Discrete Fourier Transform (DFT)-based beams, sidelobes of the antenna beams have high levels. Thus, the spatial isolation of the antenna beams is degraded depending on the combined directions of the antenna beams. The high levels of the sidelobes could be lowered by applying tapering, but the tapering would also lower the output power of the antenna array. In addition, some implementation impairments, such as (a) limited amplitude, phase resolution, accuracy, (b) limited calibration accuracy, and (c) temperature drift, will degrade the shape of the antenna beams. Moreover, using multiple antenna beams in the antenna array to improve the cell capacity and to maintain good throughout for all connected users adds lots of complexity and cost to the system (e.g., to the base station 102).

If the base station 102 has many implementation impairments, the antenna beams may include high sidelobe levels and deep nulls. Both the high sidelobe levels and the deep nulls may be randomly placed. By changing the beamforming settings in the base station 102, the positions of the sidelobes and nulls may be moved without reducing the power level of the main lobe. The present disclosure proposes to use already-available feedback signals from a wireless communication device 112, such as Channel Quality Indicator (CQI), as an indication or a measurement of the performance (e.g., SINR) and iterate the beamforming settings (e.g., phases) in the base station 102 to gradually improve the performance. By keeping track of optimal settings per spatial combination, the performance of the system gradually improves over time.

One benefit of embodiments of the present disclosure is that the accuracy of beamforming by the base station 102 may be improved while maintaining good performance. For example, design accuracy requirements and calibration accuracy requirements may be relaxed. Further, the reduction of Equivalent Isotopically Radiated Power (EIRP) due to tapering may be avoided.

The initial beamforming may be more or less aggressive. In the most aggressive scenario, tapering is not used. The phase resolution and the antenna calibration accuracy may be relaxed. In other scenarios, a bit less aggressive beamforming is used with somewhat more tapering.

Convergence solutions after permutations or iterations of the phase settings per each antenna branch may be complicated since it is easy to arrive in a local maxima. It may be desirable to start with testing some random combinations, select the best combination from the random combinations, and then iterate for each wireless communication device 112 to minimize interference degrading the other wireless communication devices 112.

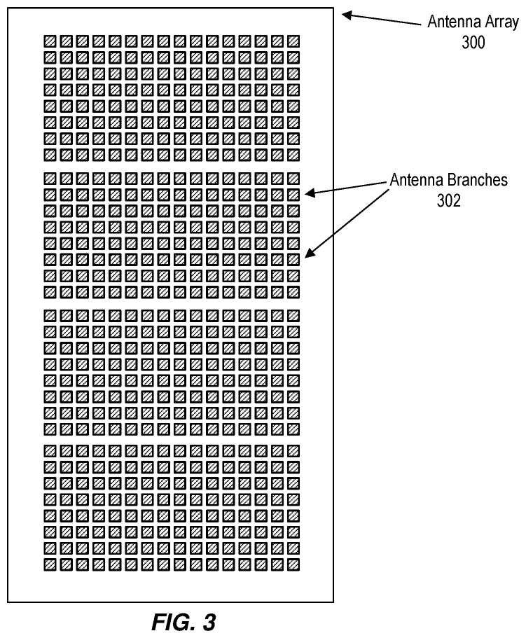

FIG. 3 illustrates an example of an antenna array 300 comprising multiple antenna branches 302, which may be installed in the base station 102. The antenna array 300 may be used for beamforming. The antenna branches 302 may be spaced in, e.g., 0.5λ (lambda) and each phase and amplitude of the antenna branches 302 may be individually controllable.

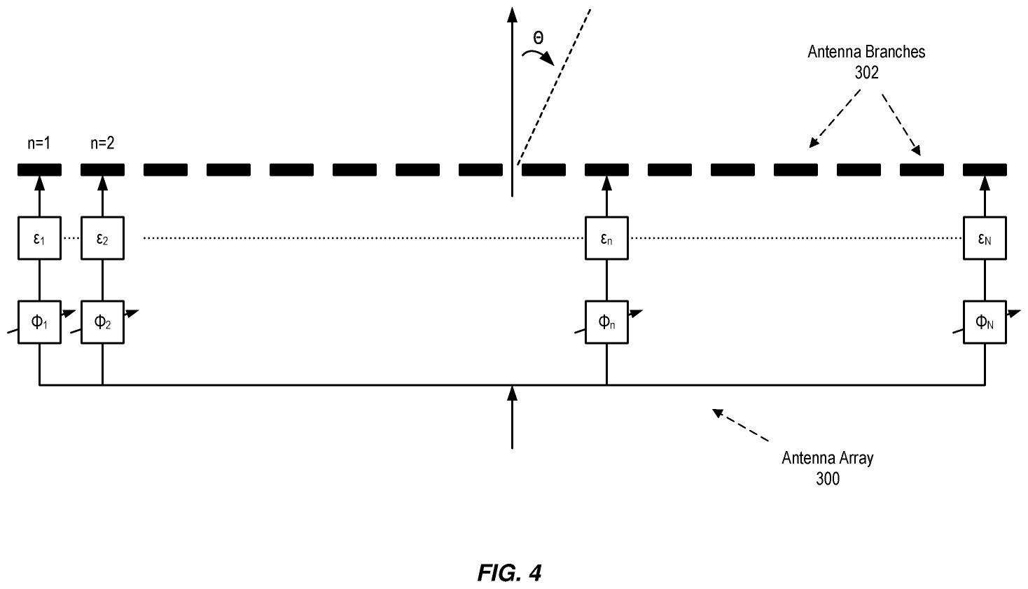

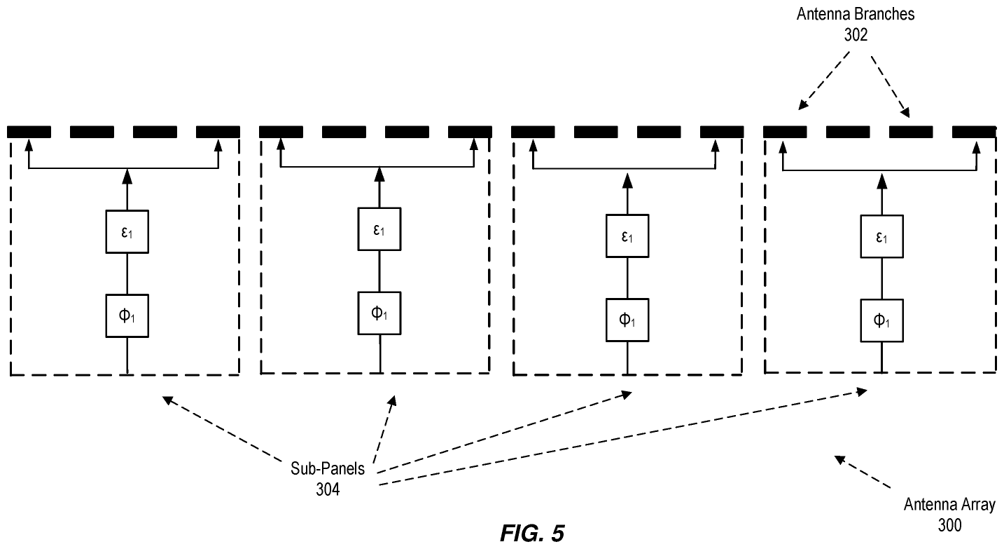

FIG. 4 illustrates an example embodiment of the antenna array 300 in which the antenna array 300 is a linear one-dimensional (1D) antenna array. Each antenna branch 302 encounters phase and amplitude errors (∈). Means to adjust the errors (∈), e.g. compensation circuitry (ϕ), are provided to each antenna branch 302. Alternatively, the antenna branches 302 are divided into multiple sub-panels 304. FIG. 5 illustrates an example of the antenna array 300 in which the antenna array 300 has e.g. four sub-panels 304, each of them having eight (8) antenna branches 302. Each sub-panel 304 is assumed to have certain phase and amplitude errors (∈). Means to adjust the errors (∈), e.g. compensation circuitry (ϕ), are provided to each sub-panel 304.

### I. Calibration of Intra-Panel Antenna Branches Toward One Served Wireless Communication Device

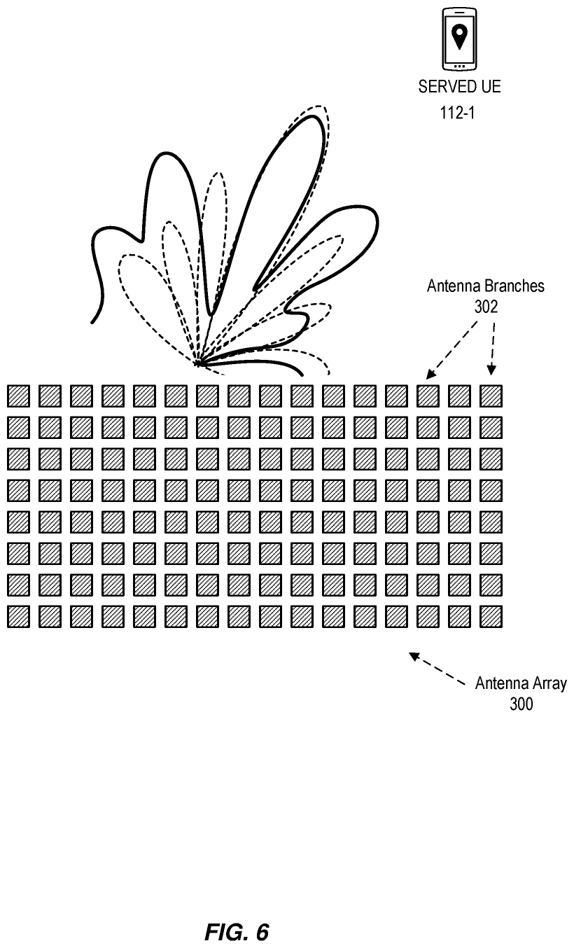

FIG. 6 illustrates a method of calibrating intra-panel antenna branches 302 toward one served wireless communication device 112. In one embodiment, the antenna array 300 is calibrated by maximizing the Signal-to-Noise Ratio (SNR) measured in one wireless communication device 112 (or several wireless communication devices 112) by, in turn, maximizing the CQI that is fed back to the base station 102 from the served wireless communication device 112.

The CQI is one of the already-existing channel quality measurements in the communication system like 5G. Normally, the CQI is used by the wireless communication device 112 to propose or choose a different channel or propose a different spatial pre-coding scheme in the base station. The CQI is also a measurement of the SNR or the SINR. Thus, each CQI received from the wireless communication devices 112 indicates the SNRs or SINRs at the wireless communication devices 112. The CQI may also be combined with a Received Signal Strength Indicator (RSSI). The RSSI estimates how much the SINR is degraded by thermal noise.

One embodiment of the present disclosure is directed to (a) change the amplitudes and/or the phases of all the antenna branches 302 of the antenna array 300 in an iterative fashion, (b) monitor the response in one wireless communication device 112 (or several wireless communication devices 112) with respect to, e.g., the CQI or any other measurements of the SNR or the SINR, and then further (c) change the amplitudes or the phases as to, in some asymptotic manner, arrive at the optimum distribution, or at least at a nearby local maximum.

### I.A. Programmatic Flow Charts

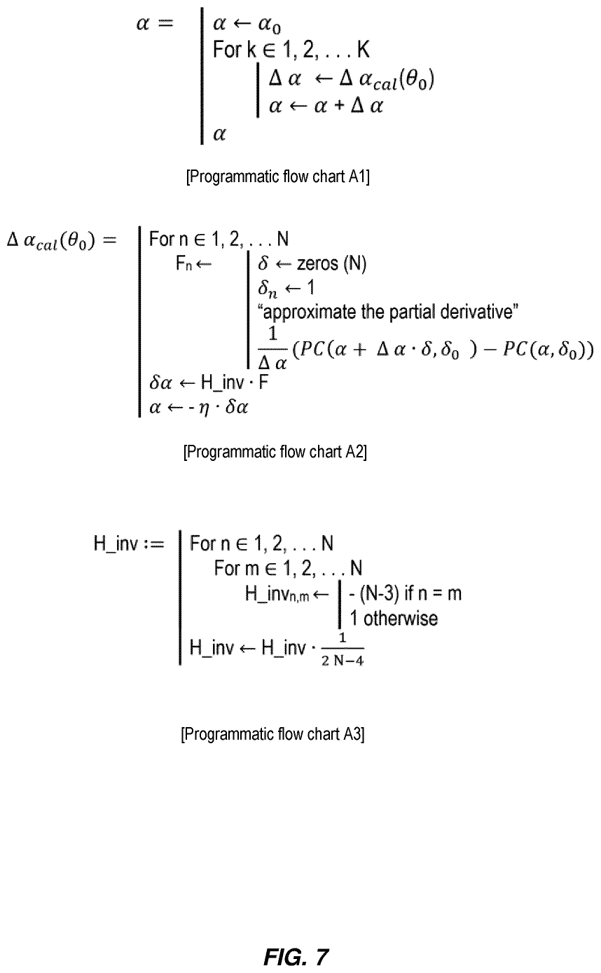

The above embodiment of calibrating intra-panel antenna branches 302 toward one served wireless communication device 112 may be further explained with the programmatic flow charts in FIG. 7. First, the programmatic flow chart A1 in FIG. 7 discloses that the phases (or the amplitudes) of the antenna branches 302 are changed by the K-number of iterations. α is a phase (or an amplitude) vector and α₀ is an initial phase (or an amplitude) vector. The vertical line in the programmatic flow chart indicates the internal part of the loop calculations (iterations) and the left arrow is an assignment equal sign. Graphically, the arrow may be interchanged by an equal sign.

Δα_{cal} is the difference between the phase vector at the iteration turn k−1 and the iteration turn k. Δα_{cal} is expressed in the programmatic flow chart A2 in FIG. 7, where the PC is the measurements of the SNR or the SINR (e.g., the CQI) by the one served wireless communication device 112. H_inv in the programmatic flow chart A2 in FIG. 7 is the inverse of the Hessian matrix in an approximate form. The H_inv is expressed in programmatic flow chart A3 in FIG. 7. Mathematical expressions corresponding to the function “PC” (including the inverse of the Hessian matrix) in the programmatic flow chart A2 are further explained below.

### I.B. Mathematical Expressions

The above functions used to calibrate the intra-panel antenna branches 302 toward one served wireless communication device 112 may be further explained with the following mathematical expressions.

I.B.i. Functions for Finding Maximum Values

Maximum gain and throughput from the antenna array 300 may be accomplished when all phases of the antenna branches 302 in the antenna array 300 are co-aligned with respect to the amplitude and the phase of the antenna array 300. That is, calibrating the antenna array 300 by co-aligning the phases of the antenna branches 302 may indirectly maximize the SINR detected by the wireless communication device 112 or, equivalently, the gain of the antenna array 300.

In one embodiment, the method to iterate phases of the downlink part of the transceiver follows a Least Mean Squares (LMS) process. That is, some rules are used in the search solution that brings the search solution nearer and nearer to the optimum point of the phases of the antenna branches 302. The optimum point corresponds to a measurement of the SINR (such as the CQI) corresponding to the highest SINR detected by the wireless communication device 112.

In general, a method to find the maximum of a function is to find where the function exhibits a zero first-order derivative and the second-order derivative of the function is negative. So, finding the maximum of the function needs a knowledge of both the first-order derivative and the second-order derivative.

When the function involving searching over several parameters is used for optimization, the method is similar but instead takes on a form of being multi-dimensional. Then, the derivatives of the function have to be expressed in terms of the Gradient vector for calculating the first-order partial derivative and the Hessian matrix for calculating the second-order partial derivative. As known in the art, in order to find an isolated local maximum, the Hessian matrix calculating the second-order derivate should be “Negative-Definite” or “Negative SemiDefinite.” For example, the diagonal elements of the Hessian matrix should be negative in order to find the isolated local maximum.

Specifically, the Gradient vector has the first-order partial derivatives of each parameter. The Hessian matrix has the second-order partial derivatives while keeping the first-order partial derivatives with respect to one parameter constant. So the Hessian matrix has mixed second-order partial derivatives.

An iteration scheme finding the maximum of a function depends on two variables (x and y) as shown in the following equations. Assuming that a function ƒ (x,y) in two variables (x and y), the iteration scheme including the Gradient vector (G) and the Hessian matrix (H) are shown in the below equations (1) to (4):

$$[ \begin{matrix}{x}_{k + 1} \\ {y}_{k + 1}\end{matrix} ] = [ \begin{matrix}{x}_{k} \\ {y}_{k}\end{matrix} ] - [ \begin{matrix}{η}_{1} & 0 \\ 0 & {η}_{2}\end{matrix} ] {H ( {x}_{k} , {y}_{k} )}^{- 1} G ( {x}_{k} , {y}_{k} ) \qquad ( 1 )$$

$$H ( {x}_{k} , {y}_{k} ) = [ \begin{matrix}\frac{{\partial }^{2}}{\partial x \partial x} f ( {x}_{k} , {y}_{k} ) & \frac{{\partial }^{2}}{\partial y \partial x} f ( {x}_{k} , {y}_{k} ) \\ \frac{{\partial }^{2}}{\partial x \partial y} f ( {x}_{k} , {y}_{k} ) & \frac{{\partial }^{2}}{\partial y \partial y} f ( {x}_{k} , {y}_{k} )\end{matrix} ] \qquad ( 2 )$$

$$G ( {x}_{k} , {y}_{k} ) = [ \begin{matrix}\frac{\partial }{\partial x} f ( {x}_{k} , {y}_{k} ) \\ \frac{\partial }{\partial y} f ( {x}_{k} , {y}_{k} )\end{matrix} ] \qquad ( 3 )$$

$$[ \begin{matrix}{η}_{1} & 0 \\ 0 & {η}_{2}\end{matrix} ] = scaling factor for the iteration . \qquad ( 4 )$$

The index ‘k’ indicates the specific iteration step. The scaling factors η₁ and η₂ may be used to expedite the convergence but should be used with care not to obtain oscillatory behaviors in the result of the iterations. The larger scaling factors η₁ and η₂, the less number of iterations may be required. If the scaling factors are chosen too large, there is a risk for the iteration scheme actually to diverge, instead of converging.

The above equations (1) to (4) are combined and written as the following equation (5):

$$[ \begin{matrix}{x}_{k + 1} \\ {y}_{k + 1}\end{matrix} ] = [ \begin{matrix}{x}_{k} \\ {y}_{k}\end{matrix} ] - {[ \begin{matrix}{η}_{1} & 0 \\ 0 & {η}_{2}\end{matrix} ] [ \begin{matrix}\frac{{\partial }^{2}}{\partial x \partial x} f ( {x}_{k} , {y}_{k} ) & \frac{{\partial }^{2}}{\partial y \partial x} f ( {x}_{k} , {y}_{k} ) \\ \frac{{\partial }^{2}}{\partial x \partial y} f ( {x}_{k} , {y}_{k} ) & \frac{{\partial }^{2}}{\partial y \partial y} f ( {x}_{k} , {y}_{k} )\end{matrix} ]}^{- 1} [ \begin{matrix}\frac{\partial }{\partial x} f ( {x}_{k} , {y}_{k} ) \\ \frac{\partial }{\partial y} f ( {x}_{k} , {y}_{k} )\end{matrix} ] \qquad ( 5 )$$

In one embodiment, the iteration starts with guess values, namely ‘x₀’ and ‘y₀’. The above equation (5) is rewritten as the following equation (6) when ƒ(xₖ,yₖ) is replaced with ƒ(a_{1,k}, . . . α_{n,k}).

$$[ \begin{matrix}{α}_{1 , k + 1} \\ ⋮ \\ {α}_{n , k + 1}\end{matrix} ] = [ \begin{matrix}{α}_{1 , k} \\ ⋮ \\ {α}_{n , k}\end{matrix} ] - {[ \begin{matrix}{η}_{1} & … & 0 \\ ⋮ & ⋱ & ⋮ \\ 0 & … & {η}_{n}\end{matrix} ] [ \begin{matrix}\frac{{\partial }^{2}}{\partial {α}_{1} \partial {α}_{1}} f ( {α}_{1 , k} , … {α}_{n , k} ) & … & \frac{{\partial }^{2}}{\partial {α}_{n} \partial {α}_{1}} f ( {α}_{1 , k} , … {α}_{n , k} ) \\ ⋮ & ⋱ & ⋮ \\ \frac{{\partial }^{2}}{\partial {α}_{1} \partial {α}_{n}} f ( {α}_{1 , k} , … {α}_{n , k} ) & … & \frac{{\partial }^{2}}{\partial {α}_{n} \partial {α}_{n}} f ( {α}_{1 , k} , … {α}_{n , k} )\end{matrix} ]}^{- 1} [ \text{} \begin{matrix}\frac{\partial }{\partial {α}_{1}} f ( {α}_{1 , k} , … {α}_{n , k} ) \\ ⋮ \\ \frac{\partial }{\partial {α}_{n}} f ( {α}_{1 , k} , … {α}_{n , k} )\end{matrix} ] \qquad ( 6 )$$

In one embodiment, α_{n,k} represents the phases. In other embodiments, α_{n,k} represents other parameters related to the antenna array 300, such as amplitude (errors).

In general, no strict rule exists about how to design the direction of search, which is expressed by the Hessian matrix in the above equations. The Hessian matrix in the above equation (6) is used as a suggestion and an example. In alternative embodiments, the Hessian matrix may be replaced by other direction-finding factors such as Broyden-Fletcher-Goldfarb-Shanno (BFGS) algorithm, Davidon-Fletcher-Powell (DFB) formula, and Symmetric rank-one (SR1). In one embodiment, the above equation (6) (hereinafter “first predefined function”) is used to find the maximum of a radiation pattern. Preferably, the above first predefined function needs to be expressed in power dimensions rather than complex envelope patterns.

I.B.ii. First Predefined Function Applied to Antenna Array

The above equations (including the first predefined function) may be transformed as follows when it comes to optimizing power in a particular direction of the antenna array 300. As known in the relevant art, an Array Factor (AF) represents a regular radiation pattern of the antenna array 300. The AF includes multiple parameters; the angle of observation θ, the number of elements N+1, and the inter-element distance d. The below equation (7) represents the AF in terms of wavelength, assuming that a reference antenna (Nr 1) is fixed at a phase of 0°. As shown in the below equation (7), the AF has its maximum beam pointing in a direction θ₀ because the portion of [sin(θ) -sin(θ₀)] is equal to zero when θ=θ₀.

$$AF ( α , θ ) = 1 + {{\sum }^{N}}_{n = 1} {e}^{j {α}_{n}} \cdot {e}^{- j 2 π \cdot nd \cdot ( sin ( θ ) - sin ( {θ}_{0} ) )} \qquad ( 7 )$$

In order to maximize the transmission power toward a particular radiation direction (e.g., the direction of the served wireless communication device 112), the following equation (8) is defined for optimization quantity:

$$P ( α , θ ) = {\vert AF ( α , θ ) \vert}^{2} = {AF ( α , θ )}^{*} \cdot AF ( α , θ ) \qquad ( 8 )$$

From the above equation (8), the Gradient vector is obtained as follows:

$${G}_{n} = 2 \cdot Re [ AF ( α , θ ) \cdot ( - j \cdot {e}^{- j {α}_{n}} \cdot {e}^{- j 2 π \cdot nd \cdot ( sin ( θ ) - sin ( {θ}_{0} ) )} ) ] \qquad ( 9 )$$

In the direction of radiation [θ=θ₀], the Gradient vector is expressed as follows:

$${G}_{n} = 2 \cdot Re [ AF ( α , θ ) \cdot ( - j \cdot {e}^{- j {α}_{n}} ) ] \qquad ( 10 )$$

In the same manner, the Hessian matrix is expressed as follows:

$${H}_{n , n} = 2 \cdot [ 1 + Re ( AF ( α , θ ) \cdot ( - {e}^{- j {α}_{n}} \cdot {e}^{- j 2 π \cdot nd \cdot ( sin ( θ ) - sin ( {θ}_{0} ) )} ) ) ] \qquad ( 11 )$$

$${H}_{n , m} = 2 \cdot cos ( {α}_{m} - {α}_{n} )$$

Then, in the beam direction [θ=θ₀], the above expressions for the Hessian matrix (for n=m and for n≠m) become:

$$\begin{matrix}{H}_{n , n} = 2 \cdot [ 1 + Re ( AF ( α , {θ}_{0} ) \cdot ( - {e}^{- j {α}_{n}} ) ) ] & for n = m\end{matrix} \qquad ( 12 )$$

$$\begin{matrix}{H}_{n , m} = 2 \cdot cos ( {α}_{m} - {α}_{n} ) & for n \neq m\end{matrix}$$

The above equation (3) (Gradient vector) is reproduced below as the equation (13):

$$G ( α ) = [ \text{} \begin{matrix}\frac{\partial }{\partial {α}_{1}} f ( {α}_{1 , k} , … {α}_{n , k} ) \\ ⋮ \\ \frac{\partial }{\partial {α}_{n}} f ( {α}_{1 , k} , … {α}_{n , k} )\end{matrix} ] \qquad ( 13 )$$

Power measurement of the transmission power of the antenna array 300 in the direction θ is expressed as the following equation (14):

$$P ( α , θ ) = {\vert AF ( α , θ ) \vert}^{2} \qquad ( 14 )$$

The following equation (15) shows that the Gradient vector of the power measurement may be obtained by collecting the change of power due to a change of a specific parameter such as the phase of the antenna branch in the antenna array 300:

$${G}_{n , k} ( {α}_{n , k} , θ ) = \frac{1}{Δα} \cdot ( P ( {α}_{n , k} , θ ) - P ( {α}_{n , k - 1} , θ ) ) \qquad ( 15 )$$

The scaling factor Δα in the equation (15) may be set to the actual step size in the iteration for the specific parameter.

The above equations and functions are discussed here as examples of many possible solutions to fine the optimum point for the antenna parameters (e.g., the phases) that correspond to the maximizing transmission power.

I.B.iii. Approximation of the Hessian Matrix

In one embodiment, the Hessian matrix may be simplified or approximated in order to reduce the computations in the implements of the above equations, in particular the first predefined function. In order to find the optimal point using the first predefined function, it is known in the relevant art that the diagonal elements of the Hessian matrix should be a negative value. Thus, without major loss in generality, the diagonal elements of the Hessian matrix are set to −1 (that is, Hₙₙ=−1). Likewise, the values of the non-diagonal matrix elements in the Hessian may be set to +1 (that is, Hₙₘ=1 (n≠m)). That is, the Hessian matrix may be simplified or approximated as shown in the following equation (17):

$$\begin{matrix}{H}_{n , m} = - 1 , & for n = m \\ {H}_{n , m} = 1 , & for n \neq m\end{matrix} \qquad ( 17 )$$

Based on the above equation (17) (a simplified or an approximated Hessian matrix), the inverse Hessian matrix in the equation (6) may be represented as the following equations (18) to (20):

$${H}^{- 1} = {[ \begin{matrix}- 1 & 1 & 1 \\ 1 & - 1 & 1 \\ 1 & 1 & - 1\end{matrix} ]}^{- 1} = [ \begin{matrix}a & b & b \\ b & a & b \\ b & b & a\end{matrix} ] for N = 3 examples \qquad ( 18 )$$

$$a = - \frac{N - 3}{2 N - 4} \qquad ( 19 )$$

$$b = \frac{1}{2 N - 4} \qquad ( 20 )$$

Or written a bit differently:

$${H}^{- 1} = {[ \begin{matrix}- 1 & 1 & 1 \\ 1 & - 1 & 1 \\ 1 & 1 & - 1\end{matrix} ]}^{- 1} = [ \begin{matrix}- ( N - 3 ) & 1 & 1 \\ 1 & - ( N - 3 ) & 1 \\ 1 & 1 & - ( N - 3 )\end{matrix} ] \cdot \frac{1}{2 N - 4} \qquad ( 21 )$$

The above equations (18) to (20) may not hold for a 2×2 Hessian. Then “b”=∞, as N=2. But in that special case one can use a slightly different approximation of the Hessian: for example [−2 1; 1−2].

The above equation (21), which is a simplified or approximated form of the inverse Hessian matrix, may be used to calculate the first predefined function faster in the implementations.

### I.C. Simulation Results for Calibrating Intra-Panel Antenna Branches

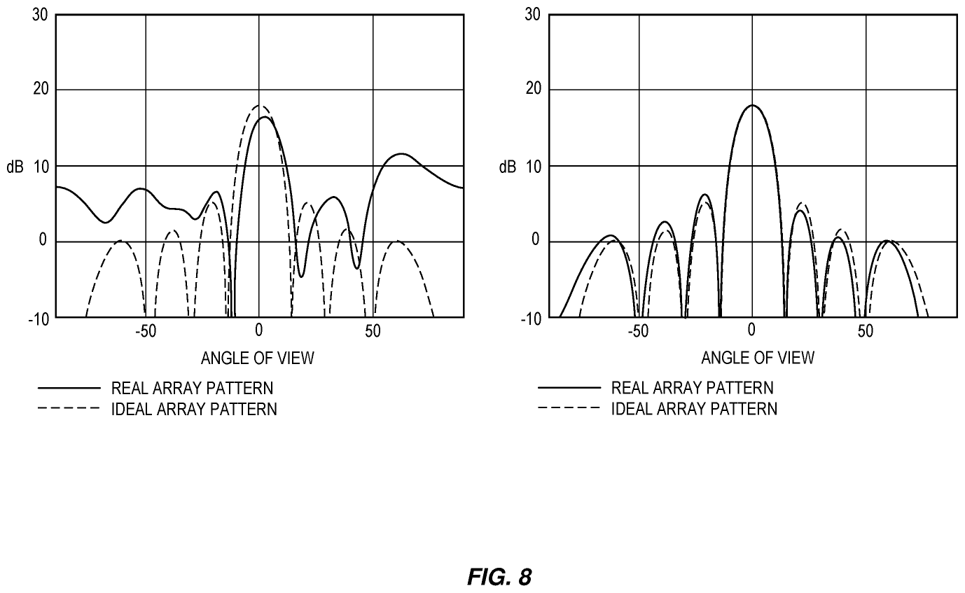

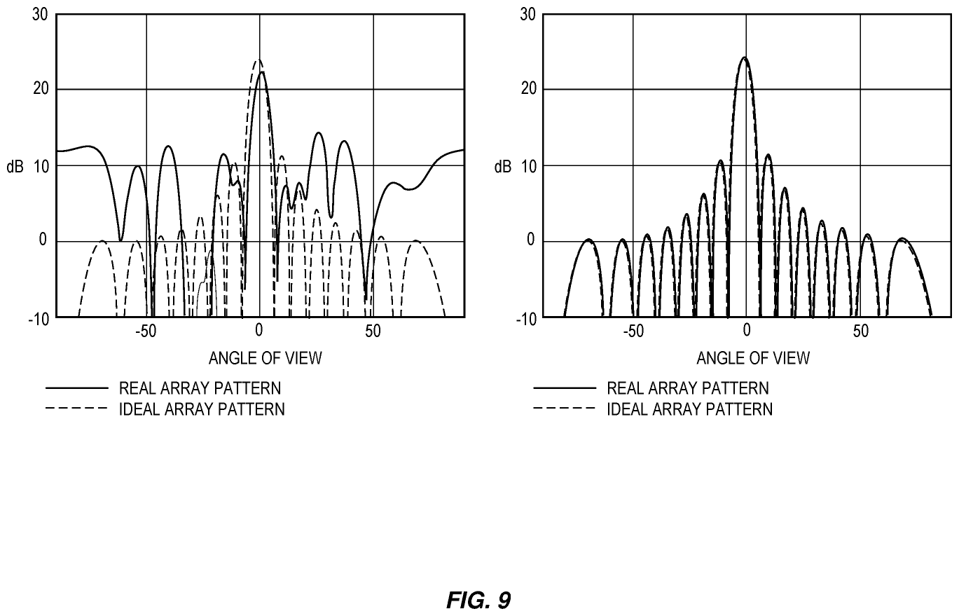

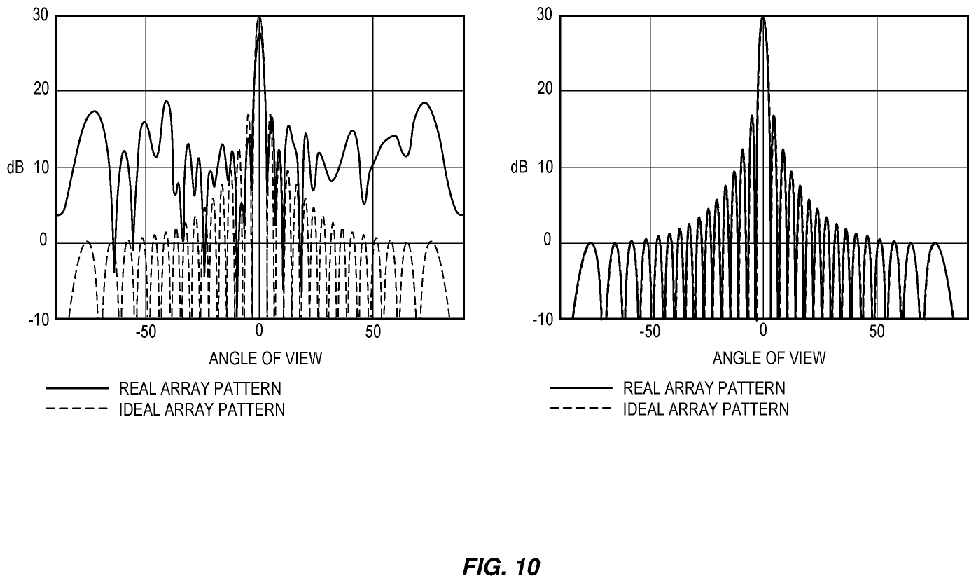

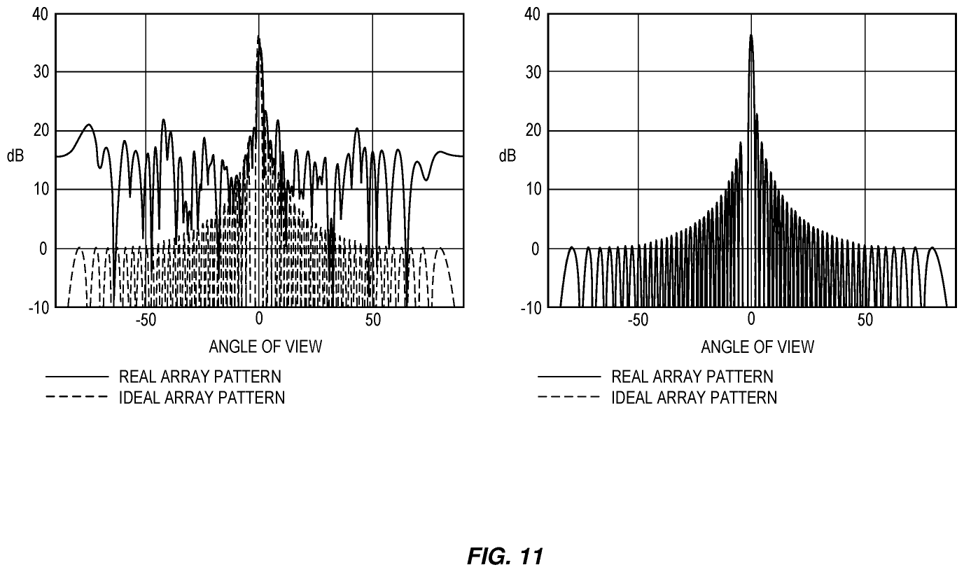

FIG. 8 to FIG. 11 illustrate the examples of calibrating linear one-dimensional (1D) linear antenna arrays with the respective antenna branches 8, 16, 32, and 64 by using the above first predefined function. The initial phase error distribution of the antenna branches has a variation of 35° RMS. The left-side graphs of the Figures illustrate the radio radiation patterns before the phases of the antenna branches are calibrated. The right-side graphs of the Figures illustrate the radio radiation patterns after the phases of the antenna branches are calibrated in accordance with the one embodiment using the above first predefined function.

### II. Calibration of Inter-Panel Antenna Branches Toward One Served Wireless Communication Device

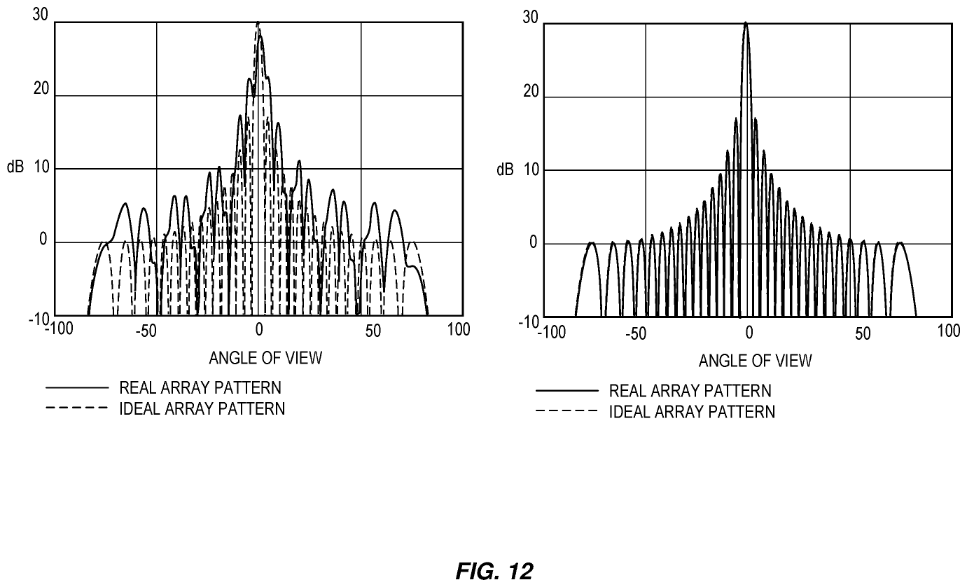

The above-described embodiment (described in the above “I. Calibration of Intra-Panel Antenna branches toward one Served Wireless Communication Device”) may be applied to the number of sub-panels 304 aligned directly adjacent to each other, which are illustrated in FIG. 5. In other words, the above-described embodiment may be applied between the sub-panels 304. Thus, the phases (or amplitudes) errors of each sub-panel are calibrated based on the above-described method. FIG. 12 illustrates the graphics of the radiation patterns in the antenna array having the multiple sub-panels 304. The left-side graph of FIG. 12 illustrates the radio radiation patterns of the 1D linear antenna array 300 having 4 sub-panels 304, each of them having eight (8) antenna branches 302 before the phases of the sub-panels 304 are not calibrated. The initial phase error distribution of the 4 sub-panels 304 has a variation of 35° RMS. The right-side graph of FIG. 12 illustrates the radio radiation patterns of the same 1D linear antenna array 300 after the phases of the sub-panels 304 are calibrated in accordance with the above-described embodiment. Compared with the left-side graph of FIG. 12, the right-side graph of FIG. 12 illustrates that the above-described embodiment virtually cancels out the phase errors over the 4 sub-panels 304 in the 1D linear antenna array 300.

### III. Calibration of Antenna Branches Toward Two Served Wireless Communication Devices

The above-described embodiment (in the above “I. Calibration of Intra-Panel Antenna branches toward one Served Wireless Communication Device”) uses only feedback information (e.g., a measurement of the SINR (such as the CQI)) from the one served wireless communication device 112, which is called as a first served wireless communication device 112. The same antenna array (i.e., same antenna branches in the intra-panel case and same sub-panels in the inter-panel case) may also be used to serve a second served wireless communication device 112. The configuration of using the same antenna array for serving at least two wireless communication devices is usually called as “digital beamforming” in the relevant art. In contrast, the configuration of using two separate antenna arrays for serving the two wireless communication devices is called as “analog beamforming.”

The above-described embodiment for calibrating the antenna branches 302 toward the one served wireless communication device 112 may be used in the same manner toward the two served wireless communication devices 112. In one embodiment, the sub-panels 304 of the antenna array 300 are assigned to the two served wireless communication devices 112, separately. For example, sub-panel #1 is calibrated under the above-described embodiment and used for the first served wireless communication device 112, while sub-panel #2 is calibrated in the same manner and used for the second served wireless communication device 112.

As stated above, the digital beamforming means that the same antenna array is used to serve multiple wireless communication devices at the same time. That is, only one antenna array may be calibrated using the feedback signal (e.g., a measurement of the SINR (such as the CQI)) from the one served wireless communication device. In one embodiment, some information from the second served wireless communication device 112 may be used to calibrate the phase and amplitude settings of the antenna array.

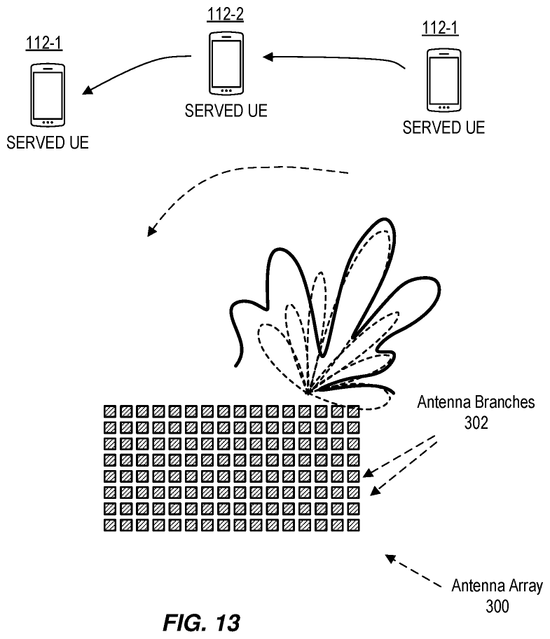

FIG. 13 illustrates an example of a calibration procedure for three served wireless communication devices 112. By using the same embodiment (in the above “I. Calibration of Intra-Panel Antenna branches toward one Served Wireless Communication Device”) toward those three served wireless communication devices 112, the antenna branches 302 are calibrated. The iteration steps (k^{th} iteration in the K-number of iterations) of the calibration procedure are divided, in certain orders (e.g., an interleaved manner) into each wireless communication device 112.

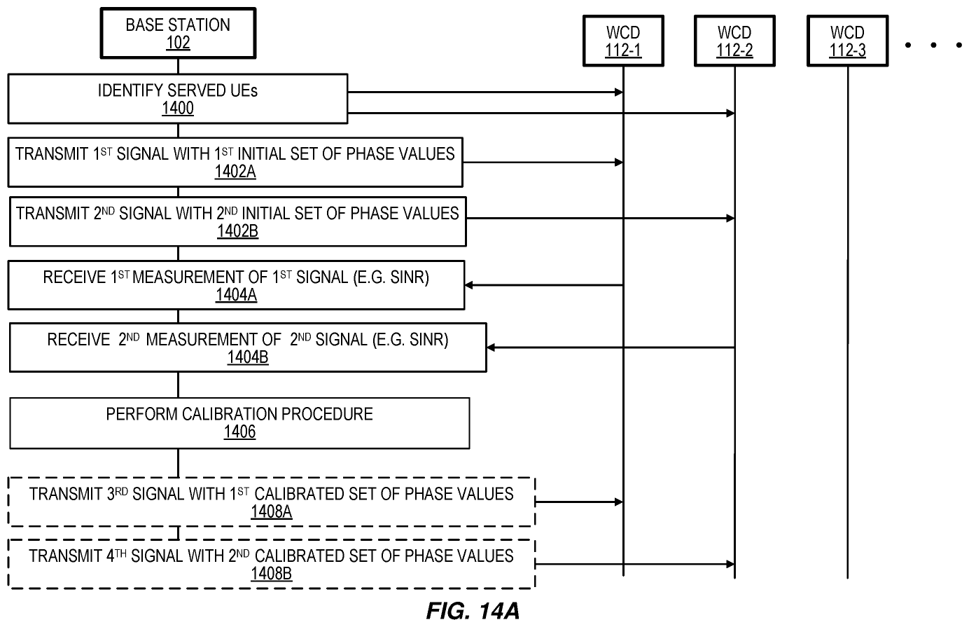

FIG. 14A illustrates a flow chart of a method of calibrating the antenna branches 302 toward the first served wireless communication device 112-1 and the second served wireless communication device 112-2. Although the flow chart in FIG. 14A illustrates the method of calibrating the antenna branches 302 toward the two served wireless communication devices, the same method may also apply only to the first served wireless communication device 112-1 or only to the second served wireless communication device 112-2.

In the step 1400, the base station 102 identifies the first served wireless communication device 112-1 and the second served wireless communication device 112-2 among the plurality of wireless communication devices 112. In the step 1402A, the base station 102 transmits a first signal with a first initial set of phase values to the first served wireless communication device 112-1. In the step 1402B, the base station 102 transmits a second signal with a second initial set of phase values to the second served wireless communication device 112-2.

In the step 1404A, the base station 102 receives a first measurement of the first signal (e.g., a measurement of the SINR of the first signal (such as the CQI)) from the first served wireless communication device 112-1. In the step 1404B, the base station 102 receives a second measurement of the second signal (e.g., a measurement of the SINR of the second signal (such as the CQI)) from the second served wireless communication device 112-2.

In the step 1406, the base station 102 performs the calibration procedure (i) based on the first measurement to provide a first calibrated set of phase values for the antenna branches 302 in the antenna array 300 and (ii) based on the second measurement to provide a second calibrated set of phase values for the antenna branches 302 in the antenna array 300.

Optionally, in the step 1408, the base station 102 transmits a third signal to the first served wireless communication device 112-1 via the antenna array 300 with the first calibrated set of phase values for the antenna branches 302 in the antenna array 300 and transmits a fourth signal to the second served wireless communication device 112-2 via the antenna array 300 with the second calibrated set of phase values for the antenna branches 302 in the antenna array 300. Optionally, the first measurement may be comprised in a CQI received from the first served wireless communication device 112-1. Optionally, the second measurement may be comprised in a CQI received from the second served wireless communication device 112-2.

FIG. 14B illustrates the sub-steps of the calibration procedure of the step 1406. In the step 1410, for each iteration k (k=0, 1, . . . , K) of the K-number of iterations, the base station 102 transmits a k-th signal to the first served wireless communication device 112-1 or to the second served wireless communication device 112-2 via the antenna array 300 with a k-th set of phase values (αₖ) applied to the antenna branches 302 in the antenna array 300. In the step 1412, the base station 102 receives a k-th measurement for the k-th signal from the first served wireless communication device 112-1 or from the second served wireless communication device 112-2. In the step 1414, the base station 102 calculates a k-th set of phase difference values (Δαₖ) based on the k-th measurement and the k-th set of phase values (αₖ). In the step 1416, the base station 102 calculates a (k+1)-th set of phase values (αₖ₊₁) based on the k-th set of phase values (αₖ) and the k-th set of phase difference values (Δαₖ).

In particular, the steps 1414 and 1416 are the same as those shown in the above first predefined function and the programmatic flow chart A1 in FIG. 7

The iteration steps (k^{th} iteration in the K-number of iterations) in the steps 1410 to 1416 of the calibration procedure are divided into the first served wireless communication device 112-1 and the second served wireless communication device 112-2, in certain orders like an interleaved manner. For example, a modulo function may be used to implement the interleaved manner of the iterations.

### III.A. Programmatic Flow Chart

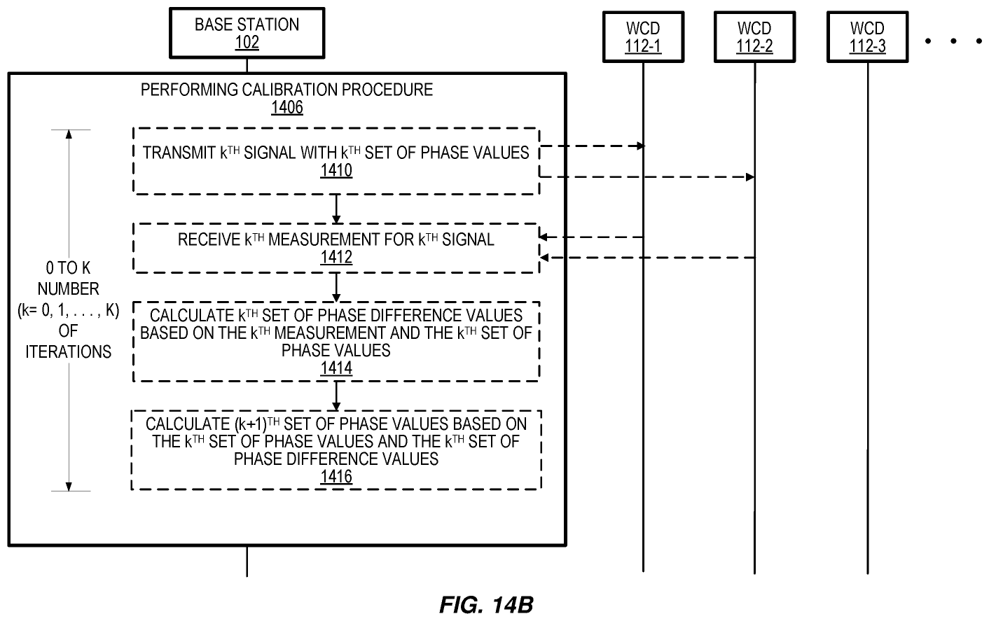

The above-described embodiment of calibrating intra-panel antenna branches 302 toward the two served wireless communication devices 112 may be further explained with the programmatic flow chart B in FIG. 15.

The programmatic flow chart B is almost identical to the above programmatic flow chart A1, except that the information (CQI, SNR, SINR or any equivalents) is used from those two or more wireless communication devices 112 to update the phase and amplitude information. As stated above, the iteration steps (k^{th} iteration in the K-number of iterations) in the programmatic flow chart B are divided in certain orders, like an interleaved manner, per each wireless communication device 112. For example, a modulo function may be used to implement the interleaved manner of the iterations. The programmatic flow chart B discloses that, if the output of the modulo function is 1, the calibration procedure is performed toward the first served wireless communication device 112-1. If the output of the modulo function is 2, the phase update is performed toward the second served wireless communication device 112-2.

### IV. Beam Isolation (Nulling) Toward One Victim Wireless Communication Device and Calibration Toward One Served Wireless Communication Device

In some situations, the calibration of the phases (or other antenna parameters like the amplitudes) in the antenna array 300 may not be enough to achieve sufficient SNR for a specific modulation. For example, the side lobes of the radio radiation patterns in the antenna array 300 may be ‘too high’ toward the second served wireless communication device 112. In the relevant art, it is called that a “beam isolation” is ‘too low’ when the side lobes toward a particular wireless communication device is ‘too high.’ In the case of digital beamforming, the side lobes may originate from the same antenna array. In the case of analog beamforming, the side lobes may originate from a separate antenna array, which is different from the antenna array used for the first served wireless communication device 112.

To prevent or alleviate the problem of the beam isolation (too high side lobes), in the relevant art, tapering of the amplitudes of the side lobes was applied after the phases of the antenna array 300 is calibrated. In one embodiment of the present disclosure, “nulling” the side lobes by using the above-disclosed method is proposed.

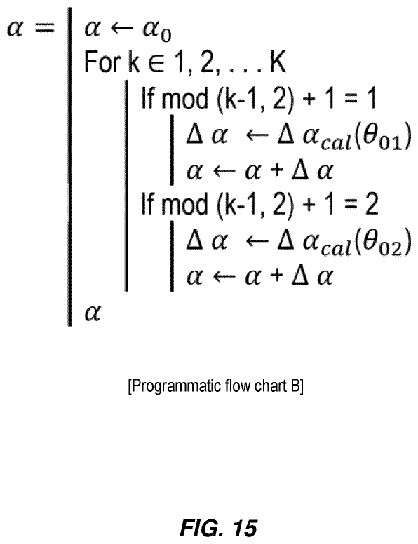

FIG. 16 illustrates an example of “nulling” the side lobes of the radio radiation patterns toward the first served wireless communication device 112-1. Nulling is a method to increase the beam isolation. A radiation beam pattern toward the direction of the victim wireless communication device 112-2 (Seethe arrows in FIG. 16) are nulled in one embodiment. With the help of feedback information (e.g., a measurement of the SINR (such as the CQI)) from the victim wireless communication device 112-2, the sidelobe level from the antenna array 300 to the served wireless communication device may be iteratively decreased by using a variation of the first predefined function that is used to increase the SINR measured by the served wireless communication device 112. That is, a “second predefined function” is used in which the Hessian matrix has diagonal elements that have opposite signs, compared with the Hessian Matrix in the first predefined function. This embodiment of optimizing the antenna beam patterns of the first served wireless communication device may be iterated independently, interleaved, or singled out to perform only nulling.

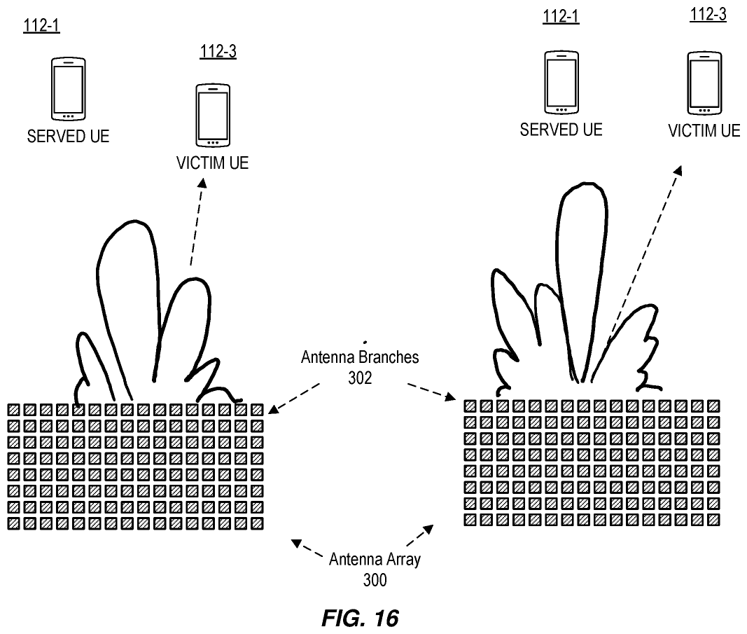

FIG. 17A illustrates a flow chart of performing the beam isolation (nulling) of the antenna branches 302 toward the first served wireless communication device 112-1 and the first victim wireless communication device 112-3. In the step 1700, the base station 102 identifies the first served wireless communication device 112-1 and the first victim wireless communication device 112-3 among the plurality of wireless communication devices 112. In the step 1402A, the base station 102 transmits a first signal with a first initial set of phase values to the first served wireless communication device 112-1. In the step 1702B, the base station 102 transmits a third signal with a third initial set of phase values to the first victim wireless communication device 112-3.

In the step 1404A, the base station 102 receives a first measurement (e.g., a measurement of the SINR of the first signal (such as the CQI)) of the first signal from the first served wireless communication device 112-1. In the step 1704B, the base station 102 receives a third measurement (e.g., a measurement of the SINR of the third signal (such as the CQI)) of the third signal from the first victim wireless communication device 112-3.

In the step 1706, the base station 102 performs a beam isolation procedure (i) based on the first measurement to provide the first calibrated set of phase values for the antenna branches 302 in the antenna array 300 and (ii) based on the third measurement to provide a third calibrated set of phase values for the antenna branches 302 in the antenna array 300.

Optionally, in the step 1708, the base station 102 transmits a fifth signal to the first served wireless communication device 112-1 via the antenna array 300 with the first calibrated set of phase values for the antenna branches 302 in the antenna array 300 and the third calibrated set of phase values for the antenna branches 302 in the antenna array 300.

FIG. 17B illustrates sub-steps of the step 1706 (beam isolation procedure), which are similar to the sub-steps in FIG. 14B. In the step 1710, for each iteration k (k=0, 1, . . . , K) of the K-number of iterations, the base station 102 transmits a k-th signal to the first served wireless communication device 112-1 or to the first victim wireless communication device 112-3 via the antenna array 300 with a k-th set of phase values (αₖ) applied to the antenna branches 302 in the antenna array 300. In the step 1712, the base station 102 receives a k-th measurement for the k-th signal from the first served wireless communication device 112-1 or from the first victim wireless communication device 112-3. In the step 1714, the base station 102 calculates a k-th set of phase difference values (Δαₖ) based on the k-th measurement and the k-th set of phase values (αₖ). In the step 1716, the base station 102 calculates a (k+1)-th set of phase values (αₖ₊₁) based on the k-th set of phase values (αₖ) and the k-th set of phase difference values (Δαₖ).

Optionally, in the above step 1714, the k-th set of phase difference values (αₖ) is calculated further based on the first predefined function in cases that the base station 102 transmits the k-th signal to the first served wireless communication device 112-1. The first predefined function comprises a first inverse Hessian matrix having first diagonal elements configured to maximize signal transmission power and a first Gradient vector that receives the k-th measurement as an input variable.

Optionally, in the same step 1714, the k-th set of phase difference values (αₖ) is calculated further based on the second predefined function in cases that the base station 102 transmits the k-th signal to the first victim wireless communication device 112-3. The second predefined function comprises a second inverse Hessian matrix having second diagonal elements configured to minimize signal transmission power and a second Gradient vector that receives the k-th measurement as an input variable.

### IV.A. Programmatic Flow Charts

In one embodiment, the above-described embodiment (in the above “I. Calibration of Intra-Panel Antenna branches toward one Served Wireless Communication Device”) is used toward the victim wireless communication device except that the first predefined function (used to find the maximum point of the transmission power) is modified to find the minimum point of the transmission power.

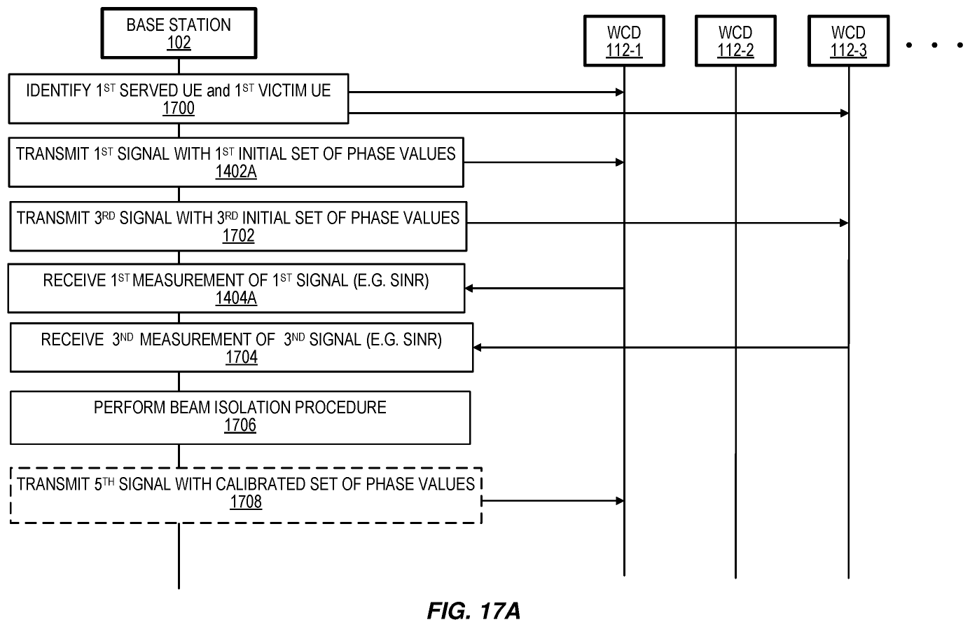

The programmatic flow charts C1 and C2 in FIG. 18 are the same as the programmatic flow chart A1 and A2, respectively, except that the diagonal elements of the Hessian matrix in the programmatic flow chart C2 have opposite signs (in order to minimize power in the direction of the victim wireless communication device 112-3), compared with the Hessian matrix in the programmatic flow chart A2. That is, the programmatic flow chart A2 recites “Δα←−ηδα” (minus n), while the programmatic flow chart C2 recites “Δα←ηδα” (plus n).

Also, the programmatic flow chart C3 in FIG. 18 illustrates the K-number of iterations. The programmatic flow chart C3 discloses that, if the output of the modulo function is 1, the beam isolation (nulling) procedure is performed toward the first victim wireless communication device 112-3. If the output of the modulo function is 2, the calibration procedure is performed toward the first served wireless communication device 112-1.

### IV.B. Simulation Results for Beam Isolation and Calibration

The above-disclosed beam isolation procedure and/or the calibration procedure are applied to sample radiation beam patterns of the antenna array 300 and the following simulation results are acquired.

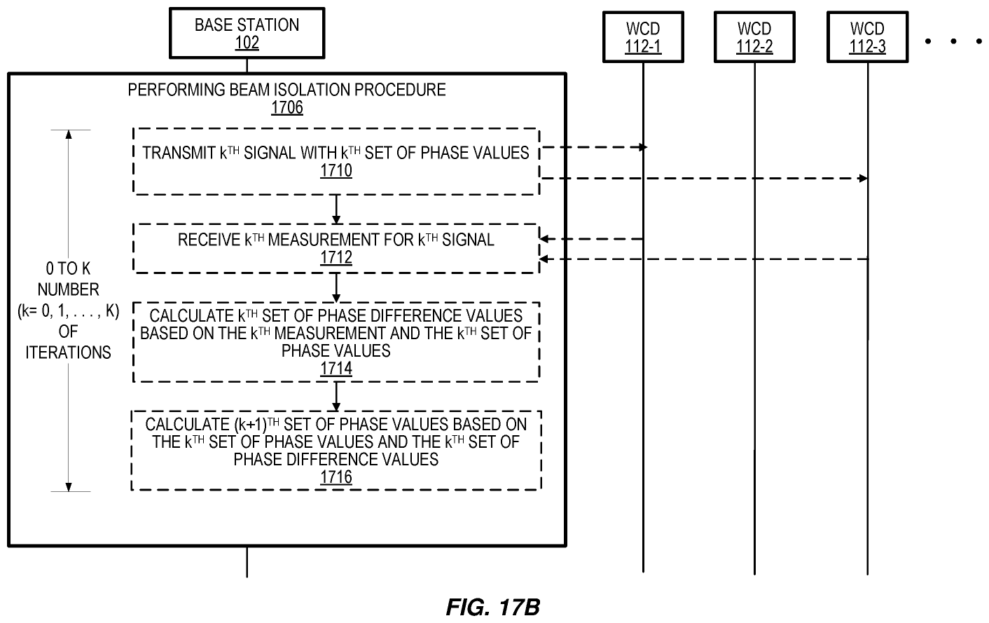

FIG. 19 illustrates that the uncalibrated radiation beam pattern (left) is processed by the beam isolation procedure, and thus the uncalibrated radiation beam pattern (right) has a null at the θ₁-direction.

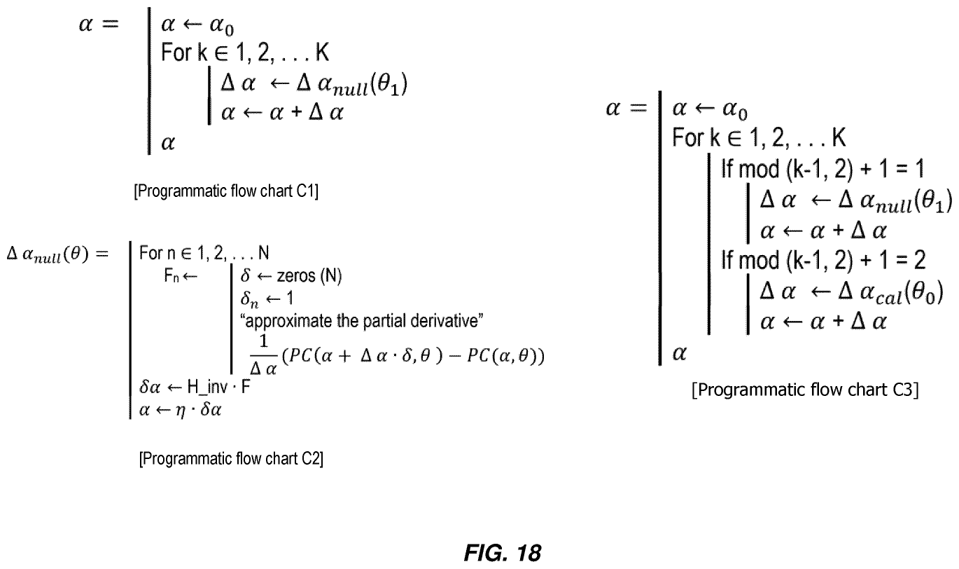

FIG. 20 illustrates that the uncalibrated radiation beam pattern (left) is processed by the beam isolation procedure, and thus the uncalibrated radiation beam pattern (right) has two nulls at the θ₁-direction and the θ₂-direction.

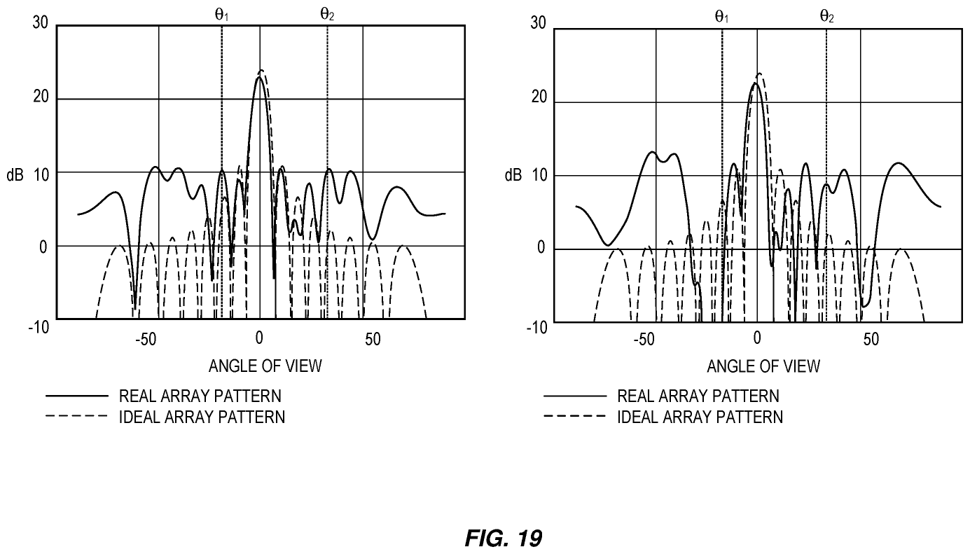

FIG. 21 illustrates that the uncalibrated radiation beam pattern (left) is processed by the calibration procedure and the beam isolation procedure, and thus the calibrated radiation beam pattern (right) has a null at the θ₁-direction.

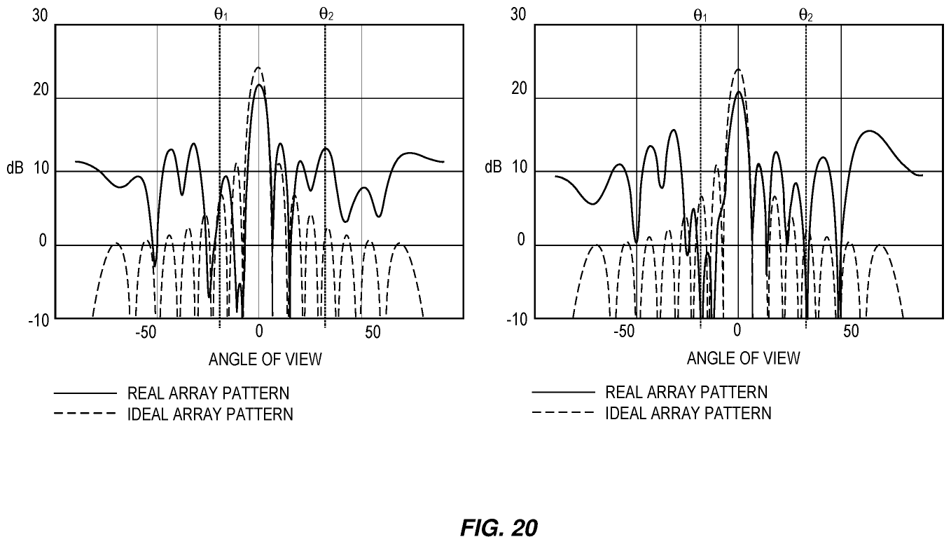

FIG. 22 illustrates that the calibrated radiation beam pattern (left) is processed by the beam isolation procedure, and thus the calibrated radiation beam pattern (right) has two nulls at the θ₁-direction and the θ₂-direction.

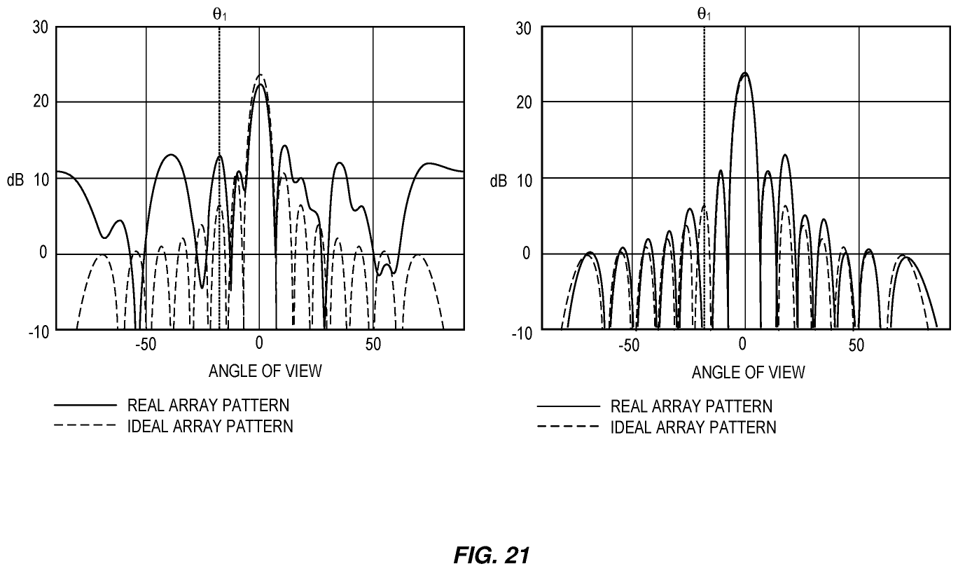

FIG. 23 illustrates that the uncalibrated radiation beam pattern (left) is processed by the beam isolation procedure and the calibration procedure, and thus the calibrated radiation beam pattern (right) has two nulls at the θ₁-direction and the θ₂-direction.

### V. Additional Embodiments

### V.A. Beam Isolation (Nulling) Toward Two Victim Wireless Communication Devices and Calibration Toward One Served Wireless Communication Device

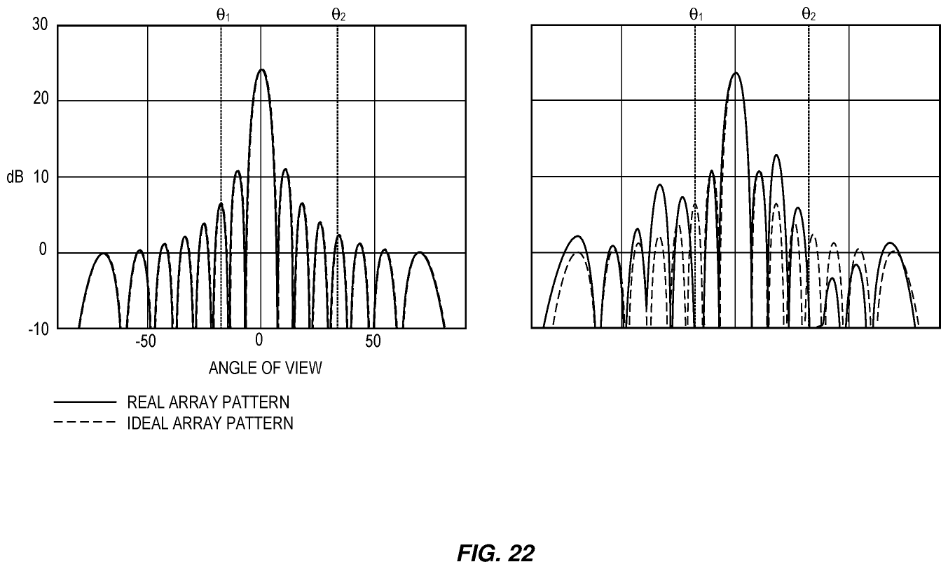

FIG. 24 illustrates that the base station 102 performs the beam isolation (nulling) procedures towards the first victim wireless communication device 112-3A and the second victim wireless communication device 112-3B, and the calibration procedure toward the first served wireless communication device 112-1, e.g., in an interleaved manner or in sequential order.

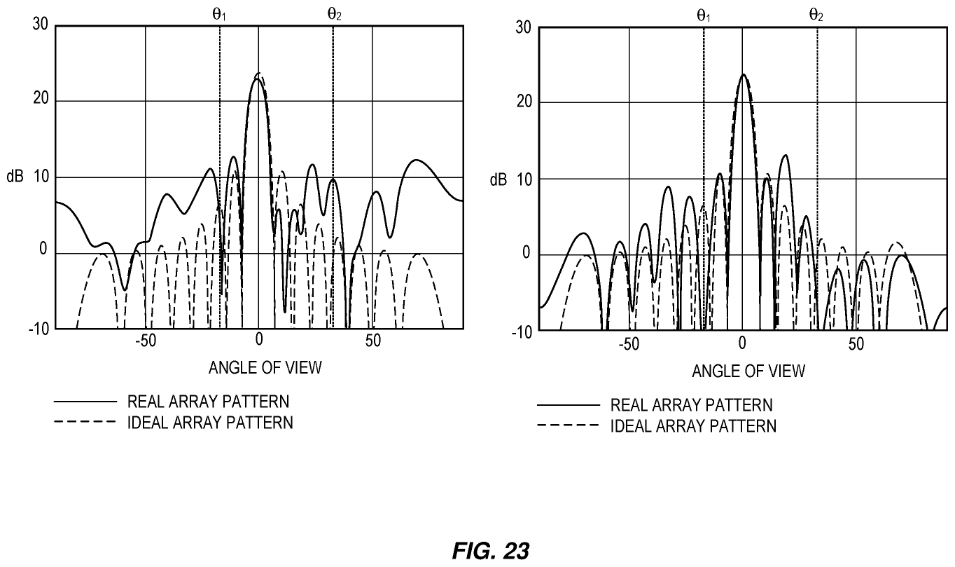

The programmatic flow chart D in FIG. 25 illustrates that the K-number of iterations are divided to the two victim wireless communication devices 112-3 and the first served wireless communication device 112-1. The programmatic flow chart D discloses that, if the output of the modulo function is 1, the beam isolation procedure is performed toward the first victim wireless communication device 112-3A. If the output of the modulo function is 2, the beam isolation procedure is performed toward the second victim wireless communication device 112-3B. If the output of the modulo function is 3, the calibration procedure is performed toward the first served wireless communication device 112-1.

### V.B. Dividing Service Area

In one embodiment, to limit the search space, the service area served by the base station 102 and its antenna array 300 is divided into sections, each served by one of the subpanels in the antenna array 300. The wireless communication devices should not be placed too tight because it would be impossible to get sufficient beam isolation. The base station 102 controls the wireless communication device scheduling and thus, decides which wireless communication devices to combine for beamforming at a given time.

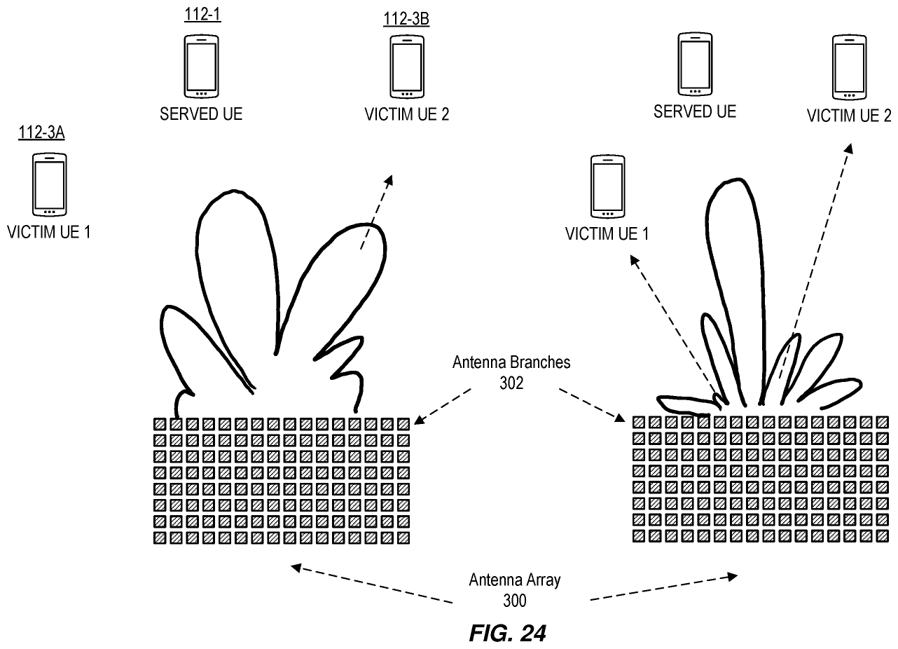

FIG. 26 illustrates that the service area is divided into subsections, each dedicated to each subpanel. In a grid-of-beam scenario, the service area is divided into N beam directions, where N depends on the service area, the panel size and allowed straddle loss. For array sizes similar to FIG. 3, several hundred beams are required to cover the full service area. By performing this partitioning of the service area, the number of possible beam combinations are, in this example, reduced from N*(N−1)*(N−2)*(N−3) to (N/4)\hat{ }4. The difference is a factor of 250, thus the beam combinations are significantly reduced.

The above-proposed method of dividing the service area into subsections may have the following advantages. Wireless communication devices with high data transfer needs may be prioritized when iterating the beamforming or the beam steering. By storing optimum settings from each wireless communication device combination and operating temperature, performance and convergence time of the wireless communication devices may be gradually improved. Scheduling could be optimized to reuse combinations that are already calibrated. Only a small portion of the service area of each base station will be frequently used. Thus, memory usages of the wireless communication devices can be optimized. Some of the wireless communication devices are stationary and have high throughput needs (Integrated Access and Backhaul (IAB) links and Fixed Wireless Access (FWA) devices). The performance in these positions will converge faster since these positions have more traffic. Part of the beamforming patterns are systematic and have similar temperature dependence. Machine learning may be used to identify these patterns and predict good settings and improve convergence time. This method may be used both locally in each base station 102 and centrally combining information from multiple base stations 102.

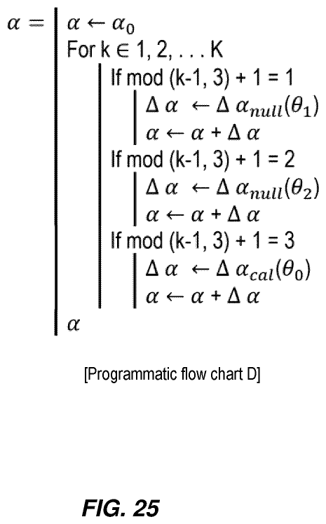

FIG. 27 is a schematic block diagram of a radio access node 2700 according to some embodiments of the present disclosure. Optional features are represented by dashed boxes. The radio access node 2700 may be, for example, a base station 102 or 106 or a network node that implements all or part of the functionality of the base station 102 or gNB described herein. As illustrated, the radio access node 2700 includes a control system 2702 that includes one or more processors 2704 (e.g., Central Processing Units (CPUs), Application Specific Integrated Circuits (ASICs), Field Programmable Gate Arrays (FPGAs), and/or the like), memory 2706, and a network interface 2708. The one or more processors 2704 are also referred to herein as processing circuitry. In addition, the radio access node 2700 may include one or more radio units 2710 that each includes one or more transmitters 2712 and one or more receivers 2714 coupled to one or more antennas 2716. The radio units 2710 may be referred to or be part of radio interface circuitry. In some embodiments, the radio unit(s) 2710 is external to the control system 2702 and connected to the control system 2702 via, e.g., a wired connection (e.g., an optical cable). However, in some other embodiments, the radio unit(s) 2710 and potentially the antenna(s) 2716 are integrated together with the control system 2702. The one or more processors 2704 operate to provide one or more functions of a radio access node 2700 as described herein. In some embodiments, the function(s) are implemented in software that is stored, e.g., in the memory 2706 and executed by the one or more processors 2704.

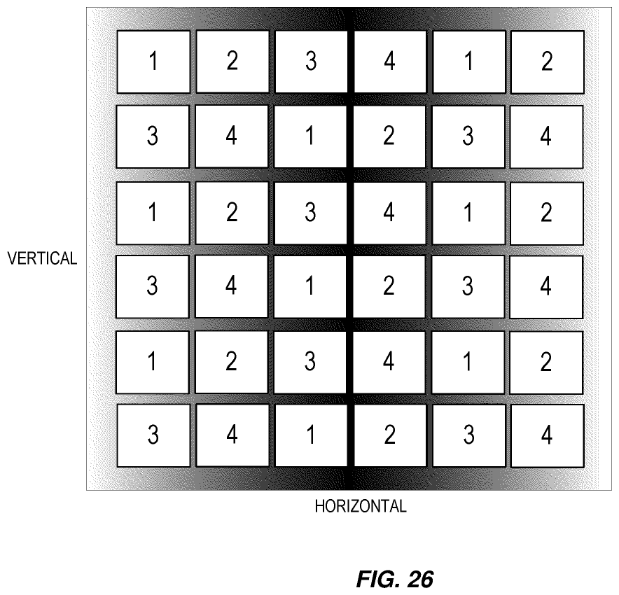

FIG. 28 is a schematic block diagram that illustrates a virtualized embodiment of the radio access node 2700 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 2700 in which at least a portion of the functionality of the radio access node 2700 is implemented as a virtual component(s) (e.g., via a virtual machine(s) executing on a physical processing node(s) in a network(s)). As illustrated, in this example, the radio access node 2700 may include the control system 2702 and/or the one or more radio units 2710, as described above. The control system 2702 may be connected to the radio unit(s) 2710 via, for example, an optical cable or the like. The radio access node 2700 includes one or more processing nodes 2800 coupled to or included as part of a network(s) 2802. If present, the control system 2702 or the radio unit(s) are connected to the processing node(s) 2800 via the network 2802. Each processing node 2800 includes one or more processors 2804 (e.g., CPUs, ASICs, FPGAs, and/or the like), memory 2806, and a network interface 2808.

In this example, functions 2810 of the radio access node 2700 described herein are implemented at the one or more processing nodes 2800 or distributed across the one or more processing nodes 2800 and the control system 2702 and/or the radio unit(s) 2710 in any desired manner. In some particular embodiments, some or all of the functions 2810 of the radio access node 2700 described herein are implemented as virtual components executed by one or more virtual machines implemented in a virtual environment(s) hosted by the processing node(s) 2800. As will be appreciated by one of ordinary skill in the art, additional signaling or communication between the processing node(s) 2800 and the control system 2702 is used in order to carry out at least some of the desired functions 2810. Notably, in some embodiments, the control system 2702 may not be included, in which case the radio unit(s) 2710 communicate directly with the processing node(s) 2800 via an appropriate network interface(s).

In some embodiments, a computer program including instructions which, when executed by at least one processor, causes the at least one processor to carry out the functionality of radio access node 2700 or a node (e.g., a processing node 2800) implementing one or more of the functions 2810 of the radio access node 2700 in a virtual environment according to any of the embodiments described herein is provided.

In some embodiments, a carrier comprising the aforementioned computer program product is provided. The carrier is one of an electronic signal, an optical signal, a radio signal, or a computer readable storage medium (e.g., a non-transitory computer readable medium such as memory).

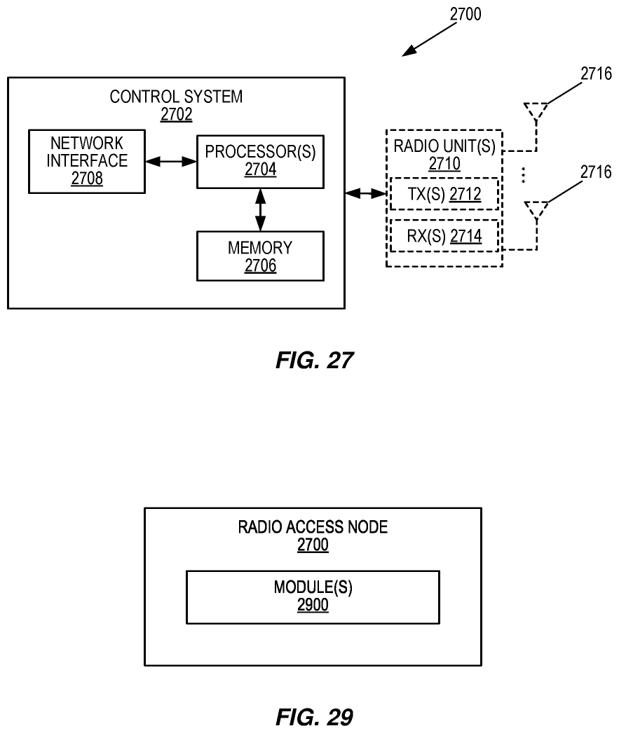

FIG. 29 is a schematic block diagram of the radio access node 2700 according to some other embodiments of the present disclosure. The radio access node 2700 includes one or more modules 2900, each of which is implemented in software. The module(s) 2900 provide the functionality of the radio access node 2700 described herein. This discussion is equally applicable to the processing node 2800 of FIG. 28 where the modules 2900 may be implemented at one of the processing nodes 2800 or distributed across multiple processing nodes 2800 and/or distributed across the processing node(s) 2800 and the control system 2702.

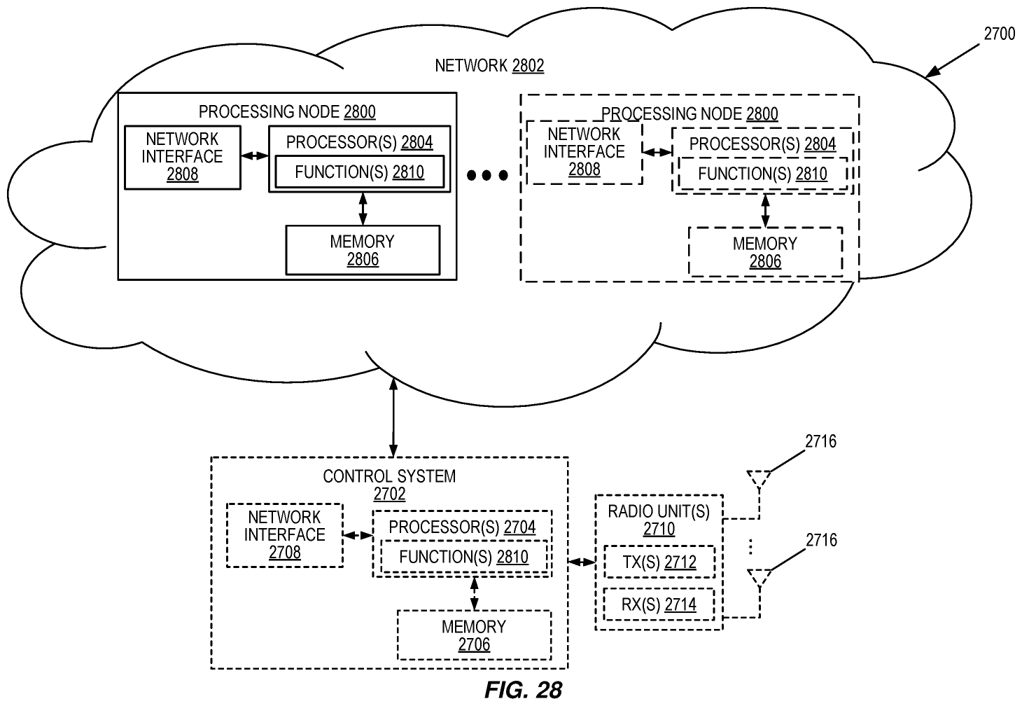

FIG. 30 is a schematic block diagram of a wireless communication device 3000 according to some embodiments of the present disclosure. As illustrated, the wireless communication device 3000 includes one or more processors 3002 (e.g., CPUs, ASICs, FPGAs, and/or the like), memory 3004, and one or more transceivers 3006 each including one or more transmitters 3008 and one or more receivers 3010 coupled to one or more antennas 3012. The transceiver(s) 3006 includes radio-front end circuitry connected to the antenna(s) 3012 that is configured to condition signals communicated between the antenna(s) 3012 and the processor(s) 3002, as will be appreciated by one of ordinary skill in the art. The processors 3002 are also referred to herein as processing circuitry. The transceivers 3006 are also referred to herein as radio circuitry. In some embodiments, the functionality of the wireless communication device 3000 described above may be fully or partially implemented in software that is, e.g., stored in the memory 3004 and executed by the processor(s) 3002. Note that the wireless communication device 3000 may include additional components not illustrated in FIG. 30 such as, e.g., one or more user interface components (e.g., an input/output interface including a display, buttons, a touch screen, a microphone, a speaker(s), and/or the like and/or any other components for allowing input of information into the wireless communication device 3000 and/or allowing output of information from the wireless communication device 3000), a power supply (e.g., a battery and associated power circuitry), etc.

In some embodiments, a computer program including instructions which, when executed by at least one processor, causes the at least one processor to carry out the functionality of the wireless communication device 3000 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

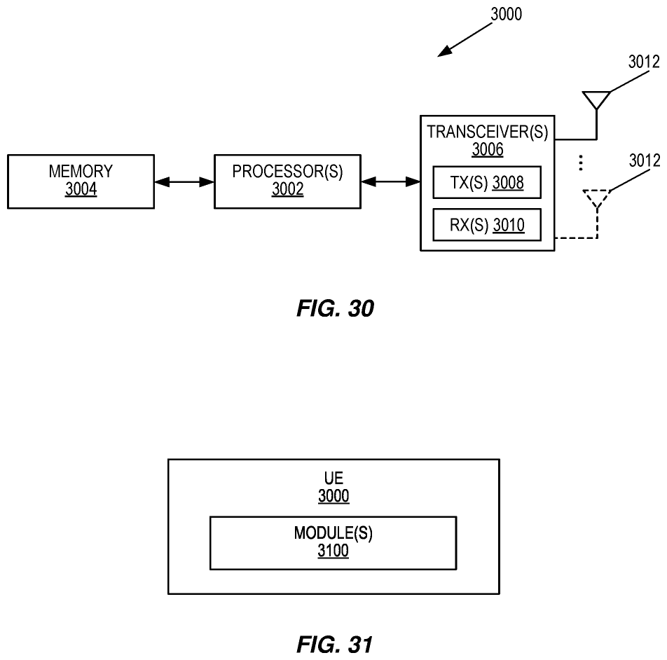

FIG. 31 is a schematic block diagram of the wireless communication device 3000 according to some other embodiments of the present disclosure. The wireless communication device 3000 includes one or more modules 3100, each of which is implemented in software. The module(s) 3100 provide the functionality of the wireless communication device 3000 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
1D One Dimensional
3GPP Third Generation Partnership Project
5G Fifth Generation
5GC Fifth Generation Core
5GS Fifth Generation System
6G Sixth Generation
AF Array Factor
AMF Access and Mobility Function
ASICs Application-Specific Integrated Circuits
AUSF Authentication Server Function
BF Beam Forming
BFGS Broyden-Fletcher-Goldfarb-Shanno
CPU Central Processing Unit
CQI Channel Quality Indicator
DFB Davidon-Fletcher-Powell
DFT Discrete Fourier Transform
DSP Digital Signal Processor
E-UTRAN Evolved Universal Terrestrial Radio Access Network
EIRP Effective Isotropic Radiated Power
eNB Enhanced or Evolved Node B
EPC Evolved Packet Core
EPS Evolved Packet System
FPGA Field Programmable Gate Arrays
FWA Fixed Wireless Access
gNB New Radio Base Station
gNB-DU gNB Distributed Unit
HSS Home Subscriber Server
IAB Integrated Access and Backhaul
IoT Internet of Things
LMS Least Mean Squares
LTE Long Term Evolution
MME Mobility Management Entity
mmW Millimeter-Wave
MTC Machine Type Communication
NEF Network Exposure Function
NF Network Function
NR New Radio
NRF Network Function (NF) Repository Function
NSSF Network Slice Selection Function
OFDM Orthogonal Frequency Division Multiplexing
PC Personal Computer
PCF Policy Control Function
P-GW Packet Data Network Gateway
QAM Quadrature Amplitude Modulation
RAM Random Access Memory
RAN Radio Access Network
RBS Radio Base Station
RF Radio Frequency
RMS Root Mean Square
ROM Read Only Memory
RRH Remote Radio Head
RSSI Received Signal Strength Indicator
SCEF Service Capability Exposure Function
SINR Signal to Interference-plus-Noise Ratio
SMF Session Management Function
SINR Signal to Interference-plus-Noise Ratio
SNR Signal-to-Noise Ratio
SR1 Symmetric rank-one
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a base station comprising an antenna array having a N number of antenna branches for optimizing signal transmission powers to a plurality of wireless communication devices, the method comprising:
identifying at least a first served wireless communication device and a second served wireless communication device among the plurality of wireless communication devices;
transmitting a first signal to the first served wireless communication device via the antenna array with a first initial set of phase values applied to the antenna branches in the antenna array;
transmitting a second signal to the second served wireless communication device via the antenna array with a second initial set of phase values applied to the antenna branches in the antenna array;
receiving a first measurement of the first signal from the first served wireless communication device;
receiving a second measurement of the second signal from the second served wireless communication device; and
performing at least one calibration procedure (i) based on the first measurement to provide a first calibrated set of phase values for the antenna branches in the antenna array and (ii) based on the second measurement to provide a second calibrated set of phase values for the antenna branches in the antenna array.

2. The method of claim 1, further comprising:
transmitting a third signal to the first served wireless communication device via the antenna array with the first calibrated set of phase values for the antenna branches in the antenna array; and
transmitting a fourth signal to the second served wireless communication device via the antenna array with the second calibrated set of phase values for the antenna branches in the antenna array.

3. The method of claim 1, wherein the first measurement is comprised in a Channel Quality Indicator, CQI, received from the first served wireless communication device.

4. The method of claim 1, wherein any of the first measurement and the second measurement comprises a Signal to Interference-plus-Noise Ratio, SINR.

5. The method of claim 1, wherein each of the first initial set of phase values or the second initial set of phase values is applied to a respective set of one or more antenna branches.

6. The method of claim 5, wherein each respective set of one or more antenna branches is a single antenna branch.

7. The method of claim 5, wherein each respective set of one or more antenna branches comprises two or more antenna branches.

8. The method of claim 1, wherein:
the at least one calibration procedure comprises a K-number of iterations; and
for each iteration k of the K-number of iterations where k=0, 1, . . . , K, performing the at least one calibration procedure comprises:
transmitting a k-th signal to the first served wireless communication device or to the second served wireless communication device via the antenna array with a k-th set of phase values (αₖ) applied to the antenna branches in the antenna array;
receiving a k-th measurement for the k-th signal from the first served wireless communication device or from the second served wireless communication device;
calculating a k-th set of phase difference values (Δαₖ) based on the k-th measurement and the k-th set of phase values (αₖ); and
calculating a (k+1)-th set of phase values (αₖ₊₁) based on the k-th set of phase values (αₖ) and the k-th set of phase difference values (Δαₖ).

9. The method of claim 8, wherein calculating a k-th set of phase difference values (Δαₖ) based on the k-th measurement and the k-th set of phase values (αₖ) comprises calculating the k-th set of phase difference values (Δαₖ) based on a first predefined function, the first predefined function comprising an inverse Hessian matrix having diagonal elements configured to maximize signal transmission power and a Gradient vector that receives the k-th measurement as an input variable.

10. The method of claim 9, wherein the first predefined function is expressed as:
$${[ \begin{matrix}{η}_{1} & … & 0 \\ ⋮ & ⋱ & ⋮ \\ 0 & … & {η}_{n}\end{matrix} ] [ \begin{matrix}\frac{{\partial }^{2}}{\partial {α}_{1} \partial {α}_{1}} f ( {α}_{1 , k} , … {α}_{n , k} ) & … & \frac{{\partial }^{2}}{\partial {α}_{n} \partial {α}_{1}} f ( {α}_{1 , k} , … {α}_{n , k} ) \\ ⋮ & ⋱ & ⋮ \\ \frac{{\partial }^{2}}{\partial {α}_{1} \partial {α}_{n}} f ( {α}_{1 , k} , … {α}_{n , k} ) & … & \frac{{\partial }^{2}}{\partial {α}_{n} \partial {α}_{n}} f ( {α}_{1 , k} , … {α}_{n , k} )\end{matrix} ]}^{- 1} [ \text{} \begin{matrix}\frac{\partial }{\partial {α}_{1}} f ( {α}_{1 , k} , … {α}_{n , k} ) \\ ⋮ \\ \frac{\partial }{\partial {α}_{n}} f ( {α}_{1 , k} , … {α}_{n , k} )\end{matrix} ]$$
where ηᵢ is a predefined value and ƒ is a function related to the first measurement received from the first served wireless communication device or the second measurement received from the second served wireless communication device.

11. The method of claim 8, wherein the K-number of iterations are divided and assigned to the first served wireless communication device and the second served wireless communication device in an interleaved manner.

12. The method of claim 8, wherein the interleaved manner is determined by a modulo function.

13. The method of claim 1, further comprising:
identifying a first victim wireless communication device among the plurality of wireless communication devices;
transmitting a third signal to the first victim wireless communication device via the antenna array with a third initial set of phase values applied to the antenna branches in the antenna array;
receiving a third measurement of the third signal from the first victim wireless communication device; and
performing at least one beam isolation procedure (i) based on the first measurement to provide the first calibrated set of phase values for the antenna branches in the antenna array and (ii) based on the third measurement to provide a third calibrated set of phase values for the antenna branches in the antenna array.

14. The method of claim 13, further comprising transmitting a fifth signal to the first served wireless communication device via the antenna array the first calibrated set of phase values and the third calibrated set of phase values for the antenna branches in the antenna array.

15. The method of claim 13, wherein:
performing the at least one beam isolation procedure comprises a K-number of iterations; and
for each iteration k of the K-number of iterations where k=0, 1, . . . , K, performing the at least one beam isolation procedure comprises:
transmitting a k-th signal to the first served wireless communication device or the first victim wireless communication device via the antenna array with a k-th set of phase values (αₖ) applied to the antenna branches in the antenna array;
receiving a k-th measurement for the k-th signal from the first served wireless communication device or the first victim wireless communication device;
calculating a k-th set of phase difference values (Δαₖ) based on the k-th measurement and the k-th set of phase values (αₖ); and
calculating a (k+1)-th set of phase values (αₖ₊₁) based on the k-th set of phase values (αₖ) and the k-th set of phase difference values (Δαₖ).

16. The method of claim 13, wherein calculating a k-th set of phase difference values (Δαₖ) based on the k-th measurement and the k-th set of phase values (αₖ) comprises calculating the k-th set of phase difference values (Δαₖ) based on:
a first predefined function, the first predefined function comprising a first inverse Hessian matrix having first diagonal elements configured to maximize signal transmission power and a first Gradient vector that receives the k-th measurement as an input variable; or
a second predefined function, the second predefined function comprising a second inverse Hessian matrix having second diagonal elements configured to minimize signal transmission power and a second Gradient vector that receives the k-th measurement as an input variable.

17. The method of claim 16, wherein the first diagonal elements of the first inverse Hessian matrix and the second diagonal elements of the second inverse Hessian matrix have the opposite signs.

18. The method of claim 15, wherein the K-number of iterations are divided and assigned to the first served wireless communication device and the first victim wireless communication device in an interleaved manner.

19. The method of claim 18, wherein the interleaved manner is determined by a modulo function.

20. A base station comprising an antenna array having a N number of antenna branches for optimizing signal transmission powers to a plurality of wireless communication devices, the base station being configured to:
identify at least a first served wireless communication device and a second served wireless communication device among the plurality of wireless communication devices;
transmit a first signal to the first served wireless communication device via the antenna array with a first initial set of phase values applied to the antenna branches in the antenna array;
transmit a second signal to the second served wireless communication device via the antenna array with a second initial set of phase values applied to the antenna branches in the antenna array;
receive a first measurement of the first signal from the first served wireless communication device;
receive a second measurement of the second signal from the second served wireless communication device; and
perform at least one calibration procedure (i) based on the first measurement to provide a first calibrated set of phase values for the antenna branches in the antenna array and (ii) based on the second measurement to provide a second calibrated set of phase values for the antenna branches in the antenna array.

21. The base station of claim 20, wherein the base station is further configured to:
transmit a third signal to the first served wireless communication device via the antenna array with the first calibrated set of phase values for the antenna branches in the antenna array; and
transmit a fourth signal to the second served wireless communication device via the antenna array with the second calibrated set of phase values for the antenna branches in the antenna array.

22. A base station comprising an antenna array having a N number of antenna branches for optimizing signal transmission powers to a plurality of wireless communication devices and processing circuitry configured to cause the base station to:
identify at least a first served wireless communication device and a second served wireless communication device among the plurality of wireless communication devices;
transmit a first signal to the first served wireless communication device via the antenna array with a first initial set of phase values applied to the antenna branches in the antenna array;
transmit a second signal to the second served wireless communication device via the antenna array with a second initial set of phase values applied to the antenna branches in the antenna array;
receive a first measurement of the first signal from the first served wireless communication device;
receive a second measurement of the second signal from the second served wireless communication device; and
perform at least one calibration procedure (i) based on the first measurement to provide a first calibrated set of phase values for the antenna branches in the antenna array and (ii) based on the second measurement to provide a second calibrated set of phase values for the antenna branches in the antenna array.

23. The base station of claim 22, wherein the processing circuitry is further configured to:
transmit a third signal to the first served wireless communication device via the antenna array with the first calibrated set of phase values for the antenna branches in the antenna array; and
transmit a fourth signal to the second served wireless communication device via the antenna array with the second calibrated set of phase values for the antenna branches in the antenna array.
